(19) United States
(12) Patent Application Publication
(10) Pub. No.: US 2008/0091590 A1
(43) Pub. Date: Apr. 17, 2008

(54) Methods, systems and financial instruments for financing renewable energy consumer premises equipment

(76) Inventor: Gary Kremen, San Francisco, CA (US)

Correspondence Address: PERKINS COIE LLP, P.O. BOX 2168, MENLO PARK, CA, 94026, US

(21) Appl. No.: 11/653,325

(22) Filed: Jan. 12, 2007

Related U.S. Application Data
(60) Provisional application No. 60/853,050, filed on Oct. 17, 2006.

(51) Int. Cl. G06Q 40/00; G05D 11/00

(52) U.S. Cl. 705/38; 700/286; 700/291; 700/295

(57) ABSTRACT

The present invention teaches a variety of systems, methods and financial instruments for financing renewable energy consumer premises equipment (CPE). The teaching contemplates, among other things, supporting financing for a renewable energy by securing attributes of the CPE that are separate from the naked power generated by the renewable energy CPE when in operation at a consumer premises. The renewable energy CPE may be attached to a structure on the consumer premises, disposed free standing on the consumer premises, or through any other suitable means of utilizing the CPE ohn the consumer premises.

### CROSS-REFERENCE TO RELATED APPLICATIONS

The present application claims priority under 35 USC §119(e) to Kremen's U.S. Provisional Application Ser. No. 60/853,050, filed Sep. 17, 2006, which is incorporated herein by reference. The present application is related to Kremen's concurrently filed applications entitled: 1) SYSTEMS, METHODS AND FINANCIAL INSTRUMENTS FOR RENEWABLE ENERGY CONSUMER PREMISES EQUIPMENT FINANCING; 2) BILLING AND PAYMENT METHODS AND SYSTEMS ENABLING CONSUMER PREMISES EQUIPMENT; 3) METHODS FOR COST REDUCTION AND UNDERWRITING CONSIDERATIONS FOR FINANCING RENEWABLE ENERGY CONSUMER PREMISES EQUIPMENT (CPE); 4) METHOD FOR UNDERWRITING THE FINANCING OF SOLAR CONSUMER PREMISES EQUIPMENT; 5) SYSTEMS AND METHODS OF REDUCING FINANCING COSTS FOR RENEWABLE ENERGY CONSUMER PREMISES EQUIPMENT; all incorporated herein by reference

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

The present invention relates to financing consumer equipment that generates power (electricity) from a renewable energy source and is located on a consumer's premises.

### BRIEF DESCRIPTION OF THE INVENTION

Electricity or power (hereinafter used interchangeably unless otherwise noted) is an essential part of modern life. In residences, businesses, in institutions and in other locations, electricity is used in numerous ways by the consumer or end user (hereinafter “consumer”).

Power plants generate electricity that is delivered by utilities through a network of transmission and distribution lines. This network is hereinafter referred to as the “power transmission and distribution grid,” “the electric grid,” “the grid” or “power grid.” In general, a power system includes a power plant, power transmission and distribution grid (including appropriate transformers for stepping up and down the voltage as required) and the consumer's power (i.e., electricity) equipment residing on the consumers' premises (real property).

The demarcation line between the power grid and the consumer location is typically the electric meter, which is owned by the utility and the main circuit panel, which is owned or controlled by the consumer. FIG. 1 illustrates an example of a prior art power system.

As discussed, power plants generate the electricity and transmit and distribute it via the power grid. These power plants generate electricity based on different sources of energy. Such sources include, but are not limited to, fossil fuels (e.g., coal, natural gas or refined oil products), nuclear energy and renewable energy sources such as water (hydroelectric power), wind, biomass and solar energy (hereinafter “renewable energy sources”). Individual consumer power usage or consumption is measured with a power meter (or “meter”). The meter measures watts, which is a unit of energy or power. A watt is voltage multiplied by current. (While there are differences in the definitions of watts for both AC and DC power, the units of measure for both (watts) are treated similarly for purposes of this application.) A Kilowatt is 1,000 Watts. The meter also measures Kilowatt-hours (KWH), which is usage of power or energy over time or the kilowatts being used times the number of hours used. Most consumers pay electric rates based on KWH units.

The entities that purchase, sell or market power may vary. In general, these are referred to as utilities. In addition, these entities may be a not-for-profit municipal entity such as the Franklin Municipal Power and Light (electricity provider in the City of Franklin and parts of the City of Suffolk, Southampton and Isle of Wight, Va.) or Henderson Municipal Power & Light or HMP&L (owned by the City of Henderson, Ky.) an electric co-operative owned by its consumers such as Central Wisconsin Electric or Northern Virginia Electric Cooperative (NOVEC), a for-profit company owned by stockholders such as Pepco Holdings, Inc. or Dominion Virginia Power (often called an investor-owned utility).

However not all utilities own their own electrical generation equipment: distribution companies and retail services may sell power to consumers. Examples of power marketers include Green Mountain Energy or Duke Energy Marketing Corporation. Some federally owned or affiliated entities also purchase, sell, or market power. Examples of federally owned entities include Bonneville Power Administration (BPA) or the Tennessee Valley Authority (TVA). Other sources of electricity may include other utilities, power marketers and independent power producers (IPPs). IPPs, such as Calpine Corporation or certain members of the Independent Energy Producers (http://www.iepa.com) generate electricity and then sell their power in wholesale markets (such as California's PX). Any entity that purchases, sells or markets power to (or from) the consumer of power or has the primary relationship with that consumer is for the purpose of this application known as a utility.

The origin of the electricity use by the consumer may also vary. Utilities may generate, transmit and distribute all of their own electricity. Alternatively, utilities may purchase power on the wholesale market from other sources off the transmission lines. The wholesale market is a place in which power is bought and sold by entities that sell electricity to the consumer. Alternatively, the utilities can source (i.e., purchase) electricity from smaller residential, business industrial, commercial and institutional users of electricity that have the means to produce the electricity (for themselves) and sell any excess back (known as buyback) to their utility. Regulators regulate the price and terms of these buybacks transactions.

All electricity generation, transmission, distribution, purchases, trading, marketing and sales are generally regulated by two authorities: The Federal Energy Regulatory Commission (FERC) and the State Public Utility Commissions (PUCs). The Federal Power Act of 1934 as amended created FERC and has jurisdiction over interstate transactions and facilities as well as wholesale sales. The PUCs have jurisdiction over intrastate trade of electricity and regulate retail rates for consumers, approve sites for generation facilities, set buyback prices and terms from smaller, localized producers and issue relevant environmental regulations. Some States or their PUCs (to be used interchangeably in this application) allow deregulation of retail prices, the introduction of competition between utilities and the buying, marketing and selling of power within the State.

Pricing of electricity can also vary greatly depending on the regulatory authority that regulates the source of the power. A consumer's bill is based on many factors including, but not limited to the price per Kilowatt-hour and the amount of kilowatt-hours consumed or used by the consumer for a given time period that the bill covers. In addition to the kilowatt-hour charge, there are other extras included in an electricity bill such as state and local taxes, and other costs. Such other costs include, but are not limited to, equipment maintenance costs, deprecation of generation and distribution equipment, transmission costs, decommissioning costs for nuclear plants, retail and wholesale competition, weather, subsidies of varies types, etc. See Energy Information Administration www.eia.doe.gov for more details.

Daily demand for electricity is usually highest in the afternoon and early evening (on-peak). Consumers may pay different prices during different parts of the day (collectively known as “Time of Day usage pricing” or “Peak pricing”). Seasonal peaks are caused by regional weather and climatic conditions. The highest usage seasonal peak usually occurs in the summer when air-conditioning use is greatest. The price per Kilowatt-hour for electricity (power) may also change depending upon monthly (or other time period) cumulative usage (tiered pricing) as well as time of day considerations. In this way, pricing increases in “steps” as usage increases. In other words, the greater the electricity consumption, the greater the increase in price per kilowatt-hour charged to the consumer. The rise in price will increase beyond a baseline usage level. A baseline level is the minimum price charged for electricity for low usage levels. The baseline level, like many other issues involved in energy is set taking into account public policy issues and usage patterns.

Consumers face price increases for electricity over the long-term, net of any increases due to inflation. Electricity prices have steadily increased over the long-term (with decreases and increases in short-term periods). For example, residential electricity prices were predicted to increase by 10.2 percent in 2006 compared with 2005 because the costs of fuels for electricity generation have risen and retail electricity price caps have recently been loosened in some States, particularly in New England and the South Atlantic region, as a result of restructured electricity markets (http://www.eia.doe.gov/emeu/steo/pub/contents.html).

While an increase in an electric bill is unfortunate for consumers, an increase in the demand for electricity has a more disastrous consequence. The long-term demand for electricity is projected to increase. For one thing, the use of power consuming devices such as air-conditioners and computers has increased. Temperatures appear to be increasing globally. An increase in demand requires an increase in electricity production. The production often times places a strain on existing power plants. Building new power plants is expensive and subject to strict environmental review and widespread opposition. Consequently, there is a need for alternate sources of energy to supplement existing sources. Renewable power sources are one such source. In fact, renewable energy sources are quite desirable.

Specifically, renewable energy sources cause less environmental harm than non-renewable sources of power and are therefore socially and politically acceptable energy sources. There are large organizations and powerful figures that believe the exploration for and the pollutants produced by fossil fuels are destroying the environment. Nuclear electric power generation has opponents that are concerned about radioactive waste disposal as well as nuclear proliferation issues. Renewable electricity development is therefore a priority in many circles for these reasons alone. Some consumers will pay premium prices for electricity derived from renewable energy sources just on the basis of it helping the environment.

In addition, renewable, local energy generation is useful to generate power for back-up purposes in the event the utility sources are terminated (e.g., because of an outage or and arrangement with the utility. For example, under certain arrangements, the utility will terminate power supply to specific consumers during peak hours or cases of demand exceeding supply capacity. The consumer will receive discounted power rates for such concessions. This is called an interrupted power contract.

Smaller renewable energy sources are also advantageous because they generate energy locally (i.e. not at a centralized power plant). Local energy generation reduces strain on a utility power grid (in which are almost universally underinvested), and therefore increasingly unable to respond to demand. While new grid infrastructure is required to meet such demand, the reality is new infrastructure is expensive and hard to get approved. The general population resists the construction of this new infrastructure. The prospect of additional transmission lines and other electrical components adjacent home dwellings and office buildings poses real or perceived safety concerns.

Even with population approval, infrastructure will continue to face an uphill battle. To obtain proper approval, a request must endure a complicated and time consuming political process (e.g., passing through a maze of Federal, State and local government offices). For these reasons, local power generation is not only good public policy, but an effective means to avoid a political process in which additional power infrastructure projects are subject to endless investigative processes to determine the purpose, need and environmental impact statements. For a current example, see San Diego Sunrise Power Transmission Project (http://www.cpuc.ca.gov/static/hottopics/1energy/a0512014.htm). Suffice it to say, renewable, localized energy sources are quite advantageous and desirable.

Local solar energy is one of the more desirable renewable sources of energy. For one thing, solar energy can essentially be harnessed in most developed country locations with solar access. For another, solar equipment consumes no fossil fuels and generates no air pollutants. The use of solar equipment is generally regarded as environmentally safe. In addition, there are direct financial motives for investing in solar energy for electricity production that complement any consumer personal or public policy considerations. Utilities in many States are required (or voluntarily do so) for public policy reasons to credit or actually buy excess solar electricity generated by the consumer. Specifically, some States require utilities to derive a portion of their sales from renewable energy sources. Consequently, if the utilities cannot satisfy this requirement, then they must purchase the electricity from other suppliers such as an IPP or from consumers with solar equipment.

In some States, consumers are paid for surplus power (electricity) generated (as opposed to credits that can only be applied for limited future use such as in California). Such payments are usually in the form of certificates or could be actual cash payments. For example, New Jersey has a Solar Renewable Energy Certificate program (“SREC”). See http://www.njcep.com/srec/index-primary.html. According to New Jersey's SREC program, the utility will issue a SREC for every 1,000 KWH that a grid tied solar system generates. The SREC can then be sold or traded independent of the power (typically via a broker or aggregator). New Jersey's SREC Program assists in the sale of SRECs to electric suppliers that are required to invest in solar energy purchase of SRECs. New Jersey's purchase requirement is expected to increase each year. It is projected that New Jersey's SRECs' equivalent will total 90 MW of solar electricity in 2009 (enough to power 8,000 homes). In sum, the specific terms of payments and credits (i.e., net metering or dual metering as described below, certificates etc.) vary from State to State and utility to utility.

In addition to the financial benefits described above, State, Federal or other jurisdictions offer financial incentives that reduce the costs associated with the purchase, installation and sometimes the operation of solar equipment. For example, Illinois State offers a 30% rebate (up to a maximum $10,000) for the purchase of solar equipment. The State of California offers a rebate of $2.30 per watt of new capacity purchased (amount of rebate to change over time subject to certain caps and other conditions). In general, the incentives vary by State. Federal law also offers certain tax credits for the purchase of solar equipment (See www.dsireusa.org for more details on State and Federal incentives for solar equipment). Note that solar energy is one type of renewal energy. That is, other renewable energy sources may be eligible for rebates, credits, subsidies and other favorable treatments (as discussed below). (This application applies to all other renewal energy (and non-renewable) sources.)

One problem with some of the rebates or credits is that they are not received at the same time the equipment is purchased. For example, the California solar credit is running up to six months behind certified installations.

In order to receive these benefits, solar equipment typically must be properly connected to (i.e., integrated) the power (electricity) grid of the local utility in accordance with utility rules. This is known as on-grid, grid-tied, utility-interactive (UI) or grid inter-tied solar equipment or systems. These systems generate solar power and route it to the power grid. The solar power (electricity) offsets consumer electrical consumption and, in some instances, even turns the electric meter backwards by routing unused power onto the grid to supply other consumers. In many States, the utility actually credits a homeowner's account for excess solar electricity produced. This amount sometimes can be applied to other time periods when the system produces less or in time periods when electrical consumption is greater (the electricity at times may be used as a credit or may be lost in a given time period as dictated by the States). This credit arrangement is called net metering or net billing which will be discussed in more detail below. The pricing for such credits might be the wholesale price of the electricity or some other pricing dictated by the individual States' PUCs. These credits can substantially reduce or eliminate an electricity bill.

While the Federal and State incentives described above are significant, the remaining costs for the purchase of solar equipment may be beyond the amount of cash a consumer has on hand or wishes to commit. For consumers that wish to displace 75% of the consumer's electricity consumption, for example, the cost for the purchase of solar system can actually reach as such as $60,000 or more. On average, residential yearly consumption ranges from 2,000-5,000 KWH. The price for the purchase of solar systems (photovoltaic cells, inverters and other auxiliary equipment) is estimated at $9 per Watt. Consequently, the total cost (on average) of such equipment ranges from $18,000-$45,000. In Illinois for example, a solar system designed to displace 75% of electricity consumption may cost about $30,000 ($45,000 less State rebates and grants). In San Diego, the purchase price of solar equipment is estimated to cost $20,160 ($37,800 less State rebates for 75% electricity displacement). These are only examples of the costs. The actual cost of the solar equipment or system may vary widely depending upon installation complexity, location, component availability, and the size of the installed system. Suffice it to say, the costs for purchase make solar equipment prohibitive for most consumers without financing. (A good analogy is the purchase of a new automobile. That is, most consumers would be prohibited from purchasing automobiles without financing options.)

There are several existing financing options for the purchase of solar equipment. These options are predominantly based on traditional financing products like a mortgage or deed of trust, as well as the less commonly used sale purchase contract or conditional sales purchase contract. While these financial instruments differ in legal structure, they are all methods for a lender to obtain a security interest (or lien) to secure their loan with the borrowers' real property. For the purposes of this application, these methods are collectively referred to as a mortgage, real property security interest or real property mortgage.

Real property mortgages are available in many flavors. For consumers that wish to purchase a new home or building there is the purchase money mortgage. For those consumers who renovate an existing home or building there is an option of an equity line of credit or second loan. Mortgages are also available for consumers that wish to refinance their existing properties. However, these mortgages are not advantageous for the purchase of solar equipment. For consumer's intending to buy a new home, it would be difficult logistically to buy the property and the CPE simultaneously.

For consumers wishing to purchase solar equipment for an existing home, the consumer would apply for a second mortgage (or refinance the first mortgage or obtain a line of credit) in which the successful loan recipient may receive a loan. Second mortgages, however, will likely have higher interest rates because they second in priority for collection security behind the first mortgage (from credit perspective). Lines of credit or home equity loans usually have commitment, annual, use or check issuance or cash advance or other service fees, some of which accrue whether or not the line of credit is used. In all cases (first mortgages, refinances, second mortgages or lines of credit), the entire subject property would be used as collateral for the loan.

There are other disadvantages to mortgages as a vehicle for solar equipment purchase. In order to obtain a mortgage for real property, the consumer must provide proper information and documentation supporting the application including financial background such as assets, bank accounts, salary, loans, credit card debt and other debt. For new property, a down payment will be required which ranges from 0-30% of the purchase price. The consumer's debit to income ratio, loan to home value ratio, the consumer's credit information including the consumer's credit score (known commonly as a credit or FICO score) and other underwriting criteria will ultimately determine whether the consumer is awarded the loan and the loan amount. From the loan applicant's viewpoint, the process is time consuming with limited success in obtaining the loan unless the applicant satisfies lender's detailed requirements.

In addition to those disadvantages, an applicant for a mortgage will typically be charged fees which are a subset of what is collectively known as closing costs. Examples of such closing costs may be found in Appendix A below. Even with advertised “no-fee” mortgages, the consumer/borrowers are charged the foregoing fees (in reality) in the form of a higher interest rate. All of these fees or charges are both considerable and economically impractical in view of the size of the loan request. There may be other costs including pre-payment penalties for loans that pay off existing loans.

There are other options for financing solar equipment. For example, a limited number of financial institutions or lenders offer another type of loan called an Energy Efficient Mortgage (EEM). The Environmental Protection Agency (EPA) offers a financing program with lenders to provide special financing for buyers of energy efficient homes. These financing options are similar to the mortgages described above, but such mortgages are offered to potential homeowners that wish to purchase a home or refinance a home that is energy efficient or will be energy efficient after energy saving equipment is installed. In some instances, an energy rating must be obtained to determine the cost-effectiveness of the improvements. See “The Borrower's Guide To Financing Solar Energy Systems, A Federal Overview,” Second Edition, U.S. Department of Energy, 1999. In these arrangements, the lenders require similar financial information from the potential homeowner as described above and will perform the same analysis to determine whether the potential homeowner is worthy of the loan. In addition, the potential homeowner must submit additional information that supports a claim of energy conservation for the property or the lender will provide an evaluation as part of the closing costs for the loan.

In summary, while these financing options (mortgages) may be adequate, they are not optimal from the perspective of both the lender and the consumer (residential) borrower. From the viewpoint of a borrower, secured loans such as real property mortgages (of any type including home equity, home line of credit, or EEM) are difficult to obtain without the proper financial background. Borrowers must adhere to lender requirements and guidelines or pay more. In addition, new home loan borrowers must put down a substantial down payment or pay more in interest costs. As part of the loan application costs, borrowers must also pay for costs such as appraisals, title insurance, inspection fees, closing costs and escrow accounts. In view of the size of the loans needed for the solar equipment (e.g., $50,000), these costs do not make economic sense for the consumer as their average cost to obtain is in the thousands of dollars.

Lenders find mortgages equally suboptimal for financing solar equipment. In the event the borrower defaults on the mortgage, the lender must institute costly and lengthy foreclosure proceedings on the subject property. The process is not only time consuming and expensive, but the lender becomes an unwilling owner/possessor of the real property. These disadvantages affect secured lenders of all types regardless of the collateralized property (e.g., residential, business, institutional or other). The prospect of these costs and administration are high compared with the size of a loan needed to finance solar equipment, which might be $50,000 or more or as little as $10,000 or less. Suffice it to say, traditional mortgage financing do not fully meet the needs for lending for the purchase of solar CPE.

There are other secured financing methods for the purchase of solar equipment. For example, personal property loans or personal property security interest (sometimes referred to as chattel mortgages or chattel loans) are a type of mortgage that is secured by personal property instead of real property. In another words, a personal property security interest is a lien that provides a lender a security interest in personal property, as opposed to real estate (land, buildings) pledged as collateral for repayment of a loan. Personal property can be any kind of movable property, such as automobiles, jewelry, etc. A personal property security interest is normally used in financing consumer goods, such as household appliances; the lien terminates when the obligation is paid. Personal property interests are usually evidenced by a UCC (Uniform Commercial Code) filing at the Secretary of State or other government office in the State in which the personal property is located.

For non-business consumers, personal property loans or interests are disadvantageous for the purchase of solar equipment. The interest payments for personal property loans are usually not tax deductible on a federal or state level. This deprives the consumer of a very important economic benefit. In addition, the interest rates for personal property loans are typically higher because the subject property is personal, not real. The personal property can be removed from the lender's reach or made less valuable. Consequently, the loan is a greater risk for the lender (than a real property mortgage). In general, banking regulators much prefer mortgages for real property.

Further, when it comes to solar equipment, lenders do not know how to characterize such property for credit and loan purposes. Because of the intrinsic nature of solar equipment and the mechanism used to attach it to the subject real property, lenders do not know whether solar equipment constitutes “real property” (i.e., a fixture under the law) or personal property under the law. The particular characterization for the solar equipment will dictate, among other things, the proper location for recording or filing (perfecting the security interest). Real estate is recorded in the county office in which the property is located. On the other hand, personal property is typically filed at the office of the Secretary of State in which the personal property is located. Because of this confusion, the lenders are apprehensive about such loans. Such apprehension usually translates into higher interest rates with stricter restrictions.

Unsecured personal loans are another type of financing option for a consumer. They are also not an optimal choice for lenders and borrowers. Unsecured loans are typically not available at affordable interest rates for the vast majority of consumers because they do have adequate financial background and the proper relationships with lenders to receive such a loan. Lenders are cautious about making unsecured loans because such loans are higher risk than secured loans.

There is another financing option available to the consumer. In this option, the installer of the solar equipment may float (or advance) a portion of the purchase price for a solar equipment. The purchase price might also include the cost of installation. This is not attractive to the installer because they must pay many of these costs upfront. In most cases, the installers have limited working capital for such an expenditure. For this reason, installers rarely offer their own direct financing. If they do decide to offer financing, installers only offer very short-term financing. Distributors, dealers and manufactures do not even offer financing (credit) for consumer solar equipment purchasing.

There is no financing program or product available that is advantageous to lenders that wish to offer loans and borrowers that wish to borrow money for the purchase of solar equipment. It would be desirable to provide a method and/or system that would overcome the disadvantages described above with respect to the financing options for solar equipment.

### SUMMARY OF THE INVENTION

The present invention teaches a variety of systems, methods and financial instruments for financing renewable energy consumer premises equipment (CPE). The present invention contemplates, for example, supporting financing for a renewable energy by securing attributes of the CPE that are separate from the naked power generated by the CPE when in operation at a consumer premises. The renewable energy CPE may be attached to a structure on the consumer premises, disposed free standing on the consumer premises, or through any other suitable means of utilizing the CPE on the consumer premises.

The present invention contemplates a variety of business methods for financing renewable energy consumer premises equipment (CPE) by a consumer for power generation at a consumer premises, the power generated having attributes that are transferable separate from naked power. One method defines at least one attribute associated with the power generated by the renewable energy CPE, wherein the at least one attribute is transferable separate from naked power. The method then secures financing for the CPE by taking a security interest in the at least one attribute associated with power generated by the CPE.

Another embodiment of the present invention teaches financing renewable energy consumer premises equipment (CPE) by a consumer for power generation at a consumer premises, the CPE having attributes that are transferable separate from the physical assets of the CPE. One aspect contemplates securing financing for the CPE by taking a security interest in the attributes associated with the CPE. Another aspect contemplates securing financing for the CPE by taking a security interest in the power purchase agreement. An additional aspect involves defining attributes of the power generated by the CPE that are transferable separate from naked power and selling the attributes associated with power generated by the CPE to reduce an amount financed.

A financial instrument embodiment supports a consumer in financing purchase, lease, installation, and/or maintenance of renewable energy consumer premises equipment (CPE) suitable for installation and power generation at a consumer premises. According to related aspects, the financial instrument includes a security interest in at least one power attribute associated with power generated by the CPE, and a security interest in at least one power attribute associated with physical assets of the CPE.

In another aspect, the financial instrument includes a power security interest in the power generated by the CPE, a power attribute security interest in a power attribute associated with power generated by the CPE, the power attribute associated with power generated by the CPE including at least one green tag credit; and a CPE security interest in the physical assets of the CPE.

A system embodiment supports financing of a plurality of renewable energy consumer premises equipment (CPE) for a plurality of consumers at a plurality of consumer premises. According to one aspect, the system includes a plurality of financial instruments. Each specific financial instrument supports a specific consumer in financing purchase, lease, installation, and/or maintenance of a specific renewable energy consumer premises equipment (CPE) suitable for installation and power generation at a specific consumer premises. Further, each specific financial instrument includes any combination of a security interest in at least one characteristic associated with power generated by the specific CPE, a physical asset security interest in at least one characteristic associated with physical assets of the CPE, and a market supporting creating and trading the plurality of financial instruments.

A method embodiment supports financing renewable energy consumer premises equipment (CPE) for power generation at a consumer premises. The power output of the CPE is sold in a power purchase agreement or a power contract. The method comprises taking an assignment in the power purchase agreement or the power contract.

Another method embodiment supports financing renewable energy consumer premises equipment (CPE) by a consumer for power generation at a consumer premises. The CPE and/or the real property on which the CPE is disposed have a long term lease associated therewith. The method comprises taking an assignment in the long term lease associated with the CPE and/or the real property.

A further method embodiment supports financing renewable energy consumer premises equipment (CPE) by a consumer for power generation at a consumer premises. The power attributes are associated with power separate and apart from naked power. The method comprises taking an assignment in the power attributes.

Another embodiment supports financing renewable energy consumer premises equipment (CPE) by a consumer for power generation at a consumer premises. The CPE has CPE attributes associated with the CPE separate and apart from naked CPE, the method comprises taking an assignment in the CPE attributes.

### BRIEF DESCRIPTION OF THE DRAWINGS

The accompanying drawings, which are incorporated herein and constitute a part of the specification, illustrate embodiments of the invention, and together with the general description given above and the detailed description of the embodiments including the Appendices A and B given below, serve to explain the principals of the invention.

FIG. 1 illustrates a diagram of a prior art power system.

FIG. 2 illustrates a block diagram of a power system incorporating consumer premises equipment (CPE) for a real property structure.

FIGS. 2A-B illustrates net and dual metering arrangements, respectively.

FIG. 3 illustrates a method of financing the purchase of CPE in accordance with an embodiment of the present invention.

FIG. 4 illustrates routine A shown in FIG. 3

FIG. 5 illustrates routine B shown in FIG. 3.

FIG. 6 illustrates routine C shown in FIG. 3.

FIG. 7 illustrates routine D shown in FIG. 3.

FIG. 8 illustrates examples of a power proxy shown in FIG. 7.

FIG. 9 illustrates examples of the attributes of power or CPE shown in FIG. 7.

FIG. 10 illustrates routine E shown in FIG. 4.

FIG. 11 illustrates routines F, G, H, I, J and K shown in FIG. 7.

FIG. 12 is a flowchart of a method of financing the purchase of CPE in accordance with another embodiment of the present invention.

FIG. 13 is diagram of consumer power consumption.

FIG. 14 illustrates a pool of individual loans for a collateralized power obligation (CPO) in accordance with another embodiment of the present invention.

FIG. 15 illustrates a CPO in accordance with the embodiment of the present invention shown in FIG. 14.

### DETAILED DESCRIPTION OF THE INVENTION

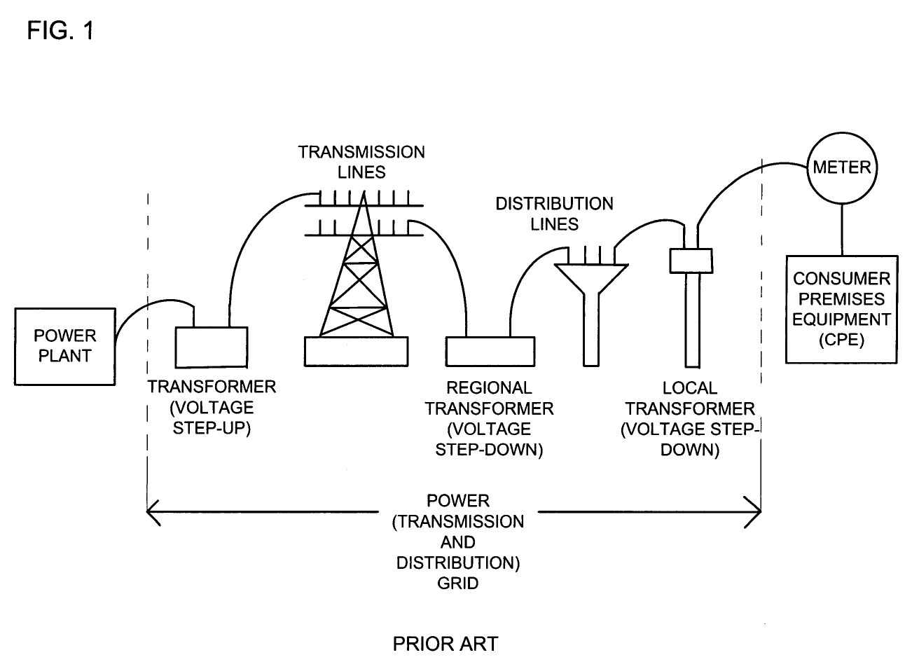

FIG. 1 is described above in the Background of the Invention.

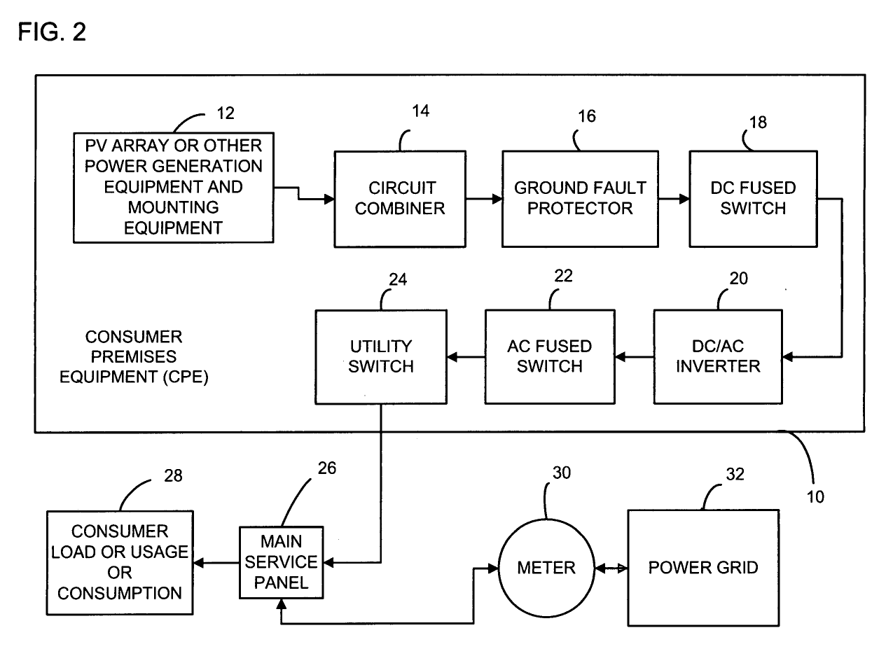

FIG. 2 illustrates consumer premises equipment 10 (also known or referred to as “CPE,” “renewable energy consumer premises equipment” and “renewable energy equipment”) that resides on a residential building, but may alternatively reside on a business, institution or other real property. According to the embodiment of FIG. 2, CPE 10 incorporates renewable energy equipment that is used by the consumer for energy generation. In this embodiment, CPE 10 includes solar components as the renewable energy equipment (source). Alternatively, any renewable equipment may be used such as wind, biomass or water (hydroelectric) energy generation equipment as well as non-renewable energy sources. Many terms used herein and the definitions for such terms are set forth in Appendix B.

The solar components described herein are collectively known as photovoltaic (“PV” or “solar”) equipment (or system). In general, there are two types of PV systems: systems that interact with the utility power grid with no battery backup capability and systems that interact with the power grid and include battery backup. In addition, there are other systems that do not interact with the grid. In the embodiment shown in FIG. 2, the PV system (equipment) interacts with the power grid 32 but does not include a battery backup. As a result, this system operates only when the utility is available. This PV system will typically provide the greatest amount of savings to a consumer per dollar of investment. However, the system will shut down during an outage, and will remain that way until utility power is restored. Note that the consumer is a homeowner or resident for this discussion, but may alternatively be a business, institution, entity or other user or purchaser of power (electricity).

CPE 10 comprises several components including a PV (photovoltaic) array 12 along with the appropriate mounting equipment. PV array 12 is made up of PV modules, which are an environmentally-sealed collections of PV cells. These cells convert the sunlight into electricity. One of the most common PV modules is 5-25 square feet in size. Usually four or more smaller modules are framed together by struts called a panel. A panel spanning 20-35 square feet in area may be used for more easily handling on a roof. CPE 10 includes mounting and wiring systems used to integrate the solar modules into the electrical systems of a residence or alternatively a business, institution or other consumer.

CPE 10 includes (as part of the wiring system) PV array circuit combiner 14, ground fault protector 16, DC fused switch 18 and DC/AC inverter 20 connected in series. PV array circuit combiner 14 is connected to PV array 12. DC fused switch 18 is used as over-current protection for the solar (PV) modules. Ground fault protection 16 is a circuit breaker. Combiner 14 is used since PV array 12 (modules) requires fusing for each module source circuit. Some inverters alternatively include the fusing and combining function within the inverter housing. Inverter 20 is designed to take the DC power from PV array 12 and convert it into standard AC power used by devices that consumes standard AC power.

CPE 10 further includes AC fused switch 22 and utility switch 24 connected in series (and connected to DC/AC inverter 20). AC fused switch 22 is used as a disconnect (i.e., as an over-current protective device (OCPD)). Utility switch 24 is used by the utility to switch off PV array 12. Most utilities require a visible-blade, lockable open switch or disconnect in the inverter's output circuit. The utility switch 24 is usually located within sight of the service-entrance meter for ease of locating by emergency response people. It should be noted that CPE 10 may include additional components or fewer components than described herein depending on power and installation requirements.

The components of CPE 10 are connected to original components including main service panel 26, consumer loads or usage (or consumption) 28, meter 30 and a local segment of the utility power grid 32. Specifically, utility switch 24 is fused and is connected to main service panel 26. The maintenance service panel 26 includes among other things the residential circuit breakers. Main panel 26 is coupled to the residential wiring and loads 28.

Meter 30 is coupled between power grid 32 and main service panel 26. Meter 30 is a device for measuring electricity consumption. In this instance, meter 30 is capable of net metering (or other alternative metering schemes discussed below). This is shown in FIG. 2A. CPE 10 is shown interconnected to power grid 32 to enable the consumer to feed any surplus or excess power (electricity) to grid 32. Meter 30 will spin forward when power (electricity) flows from power grid 32 into the residence and backward when CPE 10 (solar components) produces surplus electricity that is not immediately used. (For purposes of this application, power consumed will have a negative value and power generated will have a positive value. This convention, however, may be switched.) Excess power (electricity) is “loaded” on power grid 32.

Utilities may require an agreement for consumers to qualify for net-metering. This is known as net metering to those skilled in the state of the art. In alternative embodiments, there might be two separate meters as shown in FIG. 2B. Meter 36 is used as a measuring device for power consumed or used and meter 38 is used as a measuring device for power generated by the consumer's CPE. This “dual metering” convention may be desired by a consumer or required by a utility. This is because in some cases, the purchase price of power is different than the rate the utilities buy the power from the consumer.

The utilities may give credit or provide payment for excess electricity generated beyond power used by the consumer. In alternative embodiments, there may be two meters (as discussed above), one for forward measurement and one showing backward measurement. In this illustrative example, the consumer uses 1,000 KHW in the given time period. The consumer's CPE generates 1,600 KHW in the given time period. The price the consumer pays is $0.14 per KHW. The buyback price is $0.12 per KHW. Using net metering the consumer will receive a credit of $0.12/KHW*(1,000−1,600)=$72. Using dual metering the consumer will pay $0.14/KHW*1,000−$0.12* 1,600=$52. In other cases, the results will be different. The credit, payment or other quantifiable value for power generated by the CPE 10 is part of or known as “receivables” which will be described in more detail below.

Additional details of installation including factors effecting mounting, positioning, output and other related information are found in many power periodicals, papers and books including “A Guide to Photovoltaic (PV) System Design and Installation,” Edecon Engineering, Version 1, Jun. 14, 2001, the contents of this document being incorporated by reference herein.

The average cost for a solar system in the U.S. is approximately $30,000. Solar equipment cost may be calculated using commercial software such as the assessment tool marketed by Fat Spaniel Technologies. (See http://www.fatspaniel.com/solutions-eu-assess.html.) In addition, there are other web based tools available for calculations. An example of this is found at http://www.findsolar.com. A professional may also be used to determine the size and costs of solar equipment and installation. See “A Guide to Photovoltaic (PV) System Design and Installation,” Edecon Engineering, Version 1, Jun. 14, 2001 or other articles on this subject for more details. The solar components or equipment of CPE 10 that is subject to or may be borrowed against (may be secured) includes PV array 12, circuit combiner 14, ground fault protector 16, DC switch 18, DC/AC converter 20 and possibly other components including the mounting equipment. Note that these components may be considered fixtures depending on implementation and local laws.

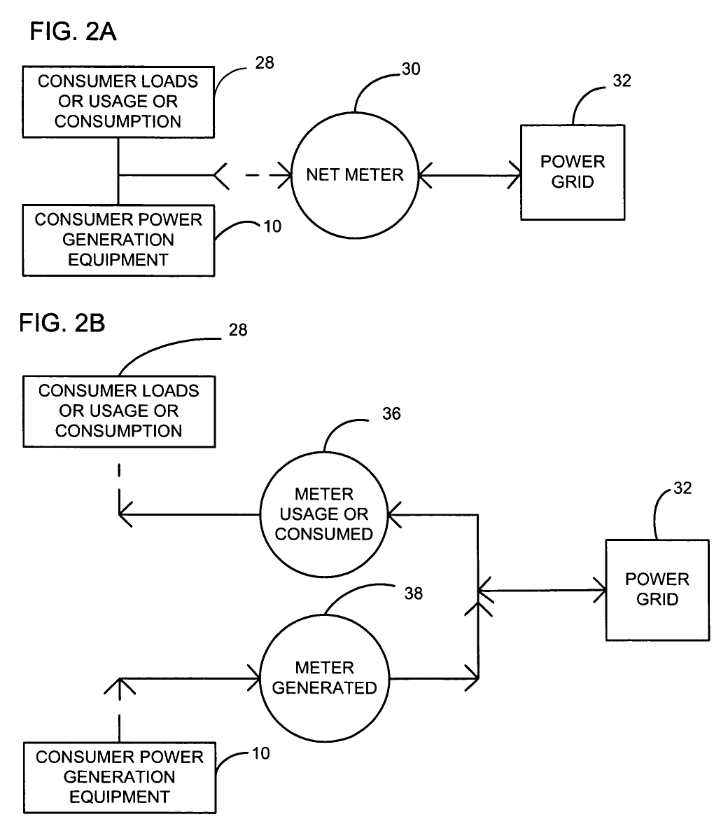

FIG. 3 is a high level flow diagram of one method of financing CPE 10 in accordance with an embodiment of the present invention. At step 50, a lender receives a loan or finance request from a consumer (borrower) for the financing of CPE 10. The consumer may submit an application for such a loan much like a consumer does for other types of loans. However, such information submitted will be abbreviated to reduce the administrative mortgage costs which make CPE harder to finance. (In certain embodiments, the general lending underwriting standards are modified and costs associated with the same are reduced for the reasons discussed below). The financing application may be received in many ways including a letter, website, email, phone and fax. As part of the financing application, the consumer may be required to submit limited financial and other information (e.g., name, social security or tax ID number, location of real property, authorization for credit information, type of loan desired, etc.) for evaluation. CPE 10 (e.g., solar components) requirements and limitations will also be determined along with the costs for such CPE 10.

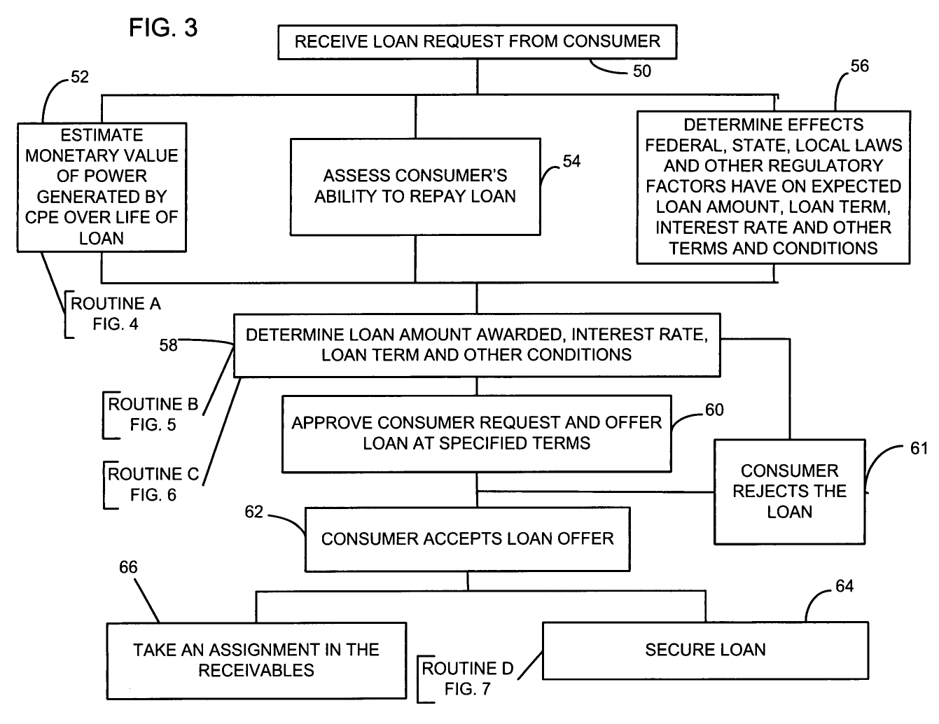

Following step 50, several steps are executed in parallel, as shown, or may be executed in any suitable manner. At step 52, the monetary value of the estimated power generated by the CPE 10 over the life of the loan is determined. Details of step 52 are set forth in routine A shown in FIG. 4. Suffice it to say, the power estimated may be excess power as measured by a net meter 30 from FIG. 2A or gross power generated and measured directly off of the meter 38 shown in FIG. 2B. At step 54, the consumer's ability to repay the loan is assessed. The consumer's credit information including FICO score are obtained. This credit information will be evaluated to assess whether the consumer will pay back the loan independent of the value of any collateral or cash flows. In addition to this assessment, the actual value for the CPE 10 may be determined. The rebates, credits, subsidies and any other benefits for the purchase of CPE10 may be taken into consideration. In addition to step 54, the effects of Federal, State and local laws as well as regulatory factors have on expected loan amount, loan term, interest rate and other terms and condition may be determined at step 56.

Federal laws such as the U.S. Department and Urban Development (HUD) rules must be reviewed (particularly if the loan is used to purchase real property). For example, HUD rules require a cool-down period in which the consumer/borrower may terminate the agreement without penalty. State laws must also be reviewed. For example, State usury laws must be reviewed to determine the specific rules and restrictions on loans and interest rates. For example, California's usury and other laws regulate the loan of money and the interest rates employed. See Title IV—Loan, Ch. 3, Loan of Money, California Civil Code Section 1912-1916 and the California Finance Lenders Law of the California Financial Code. In addition, Federal, State and local anti-predatory lending laws that also protect the consumer/borrower for fraudulent, deceptive, discriminatory or unfavorable practices must be reviewed. The lender must also adhere to licensing laws for lending money to consumers.

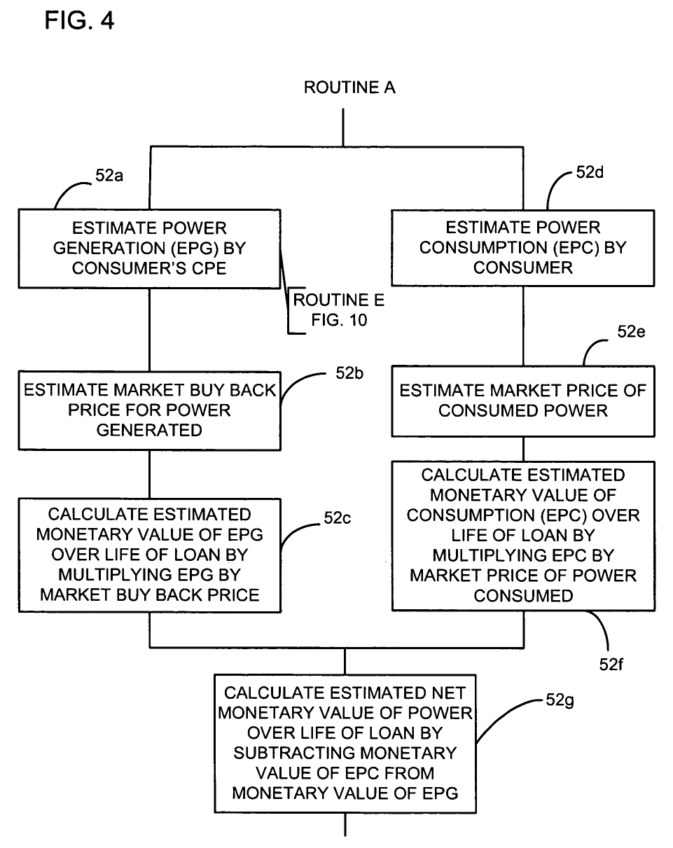

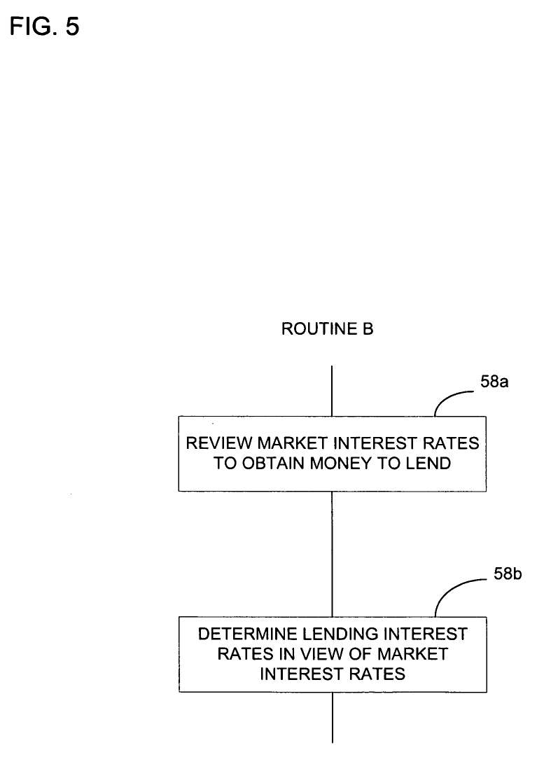

Once steps 52-56 are completed, a loan or financing amount to be offered to the consumer is determined (calculated) along with the relevant interest rate, loan term and other conditions at step 58. The amount, interest rate and other terms and conditions take into account market interest rates and conditions, as described in detail with respect to routine B in FIG. 5. In addition, other factors relating to the CPE 10 are considered as described in detail with respect to routine C in FIG. 6. Any down payment by the consumer will also be taken into consideration.

As part of this determination, applicant information is verified. As for the loan, the terms may be for a fixed monthly term or a variable term based on a payment amount the consumer prefers (and is supported by their credit information). Other terms and rates may be used including fixed or variable interest rates based on market conditions for a given credit information. Down payments may or may not be required based on the credit information and other factors. The loan application process may be done entirely through the web in real or near-real time. Execution then moves to step 60 wherein the lender approves the loan and offers the loan to the consumer at the terms determined (from steps 52-58). The consumer may be notified of such approval in many ways including a letter, email message, via website, print out or other efficient means. At this point, the consumer has the option to either accept or reject the loan at the given terms (steps 61 and 62). If the consumer rejects the loan, the process may return to step 58 wherein the loan terms are recalculated (if the lender desires). Assuming the consumer accepts the loan at the terms offered at step 62, such acceptance shall be by execution which may include notarization. Execution may be in written or electronic/digital form.

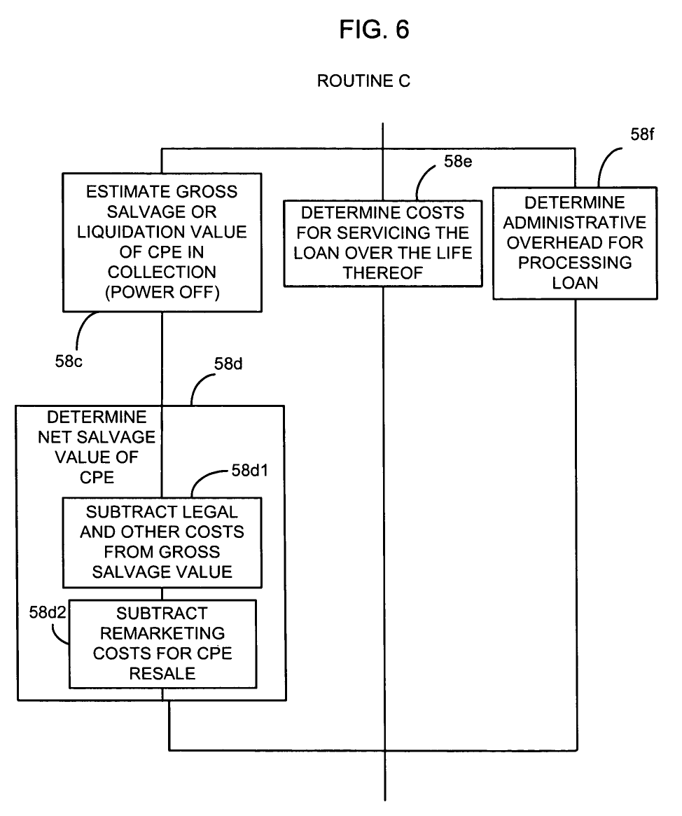

Now, the lender wants to increase its chances that it will be repaid the full amount of the loan. To this end, the lender will secure the loan or financing at step 64 as described in routine D in detail (FIG. 7). In brief, the lender may secure the loan against a power proxy, the CPE, rebates, credits and/or subsidies, a power purchase agreement, real property, and/or a conditional sales contract (or power contract). Additionally or alternatively, the lender may take or receive an assignment from the consumer for the receivables (as described below) it receives for future power generated by CPE 10 (excess or direct power off of the CPE). This is accomplished at step 66. Alternatively or in addition, the lender may take an assignment in the other power proxy elements (besides the receivables as discussed below), power attributes and/or CPE attributes (discussed below), a power purchase agreement, power contract and/or a conditional sales contract.

Note that the method of FIG. 3 was described in terms of a loan for purchase. However, the present invention contemplates a variety of financing techniques for a variety of activities including purchase, lease, installation and maintenance of the CPE 10.

With respect to the “receivables” described above, many utilities are required to either credit a consumer's account (back meter) or pay a consumer for electricity generated by CPE 10 and delivered onto the power grid 32. This payment may be in the form of a certificate, credit, money or other quantifiable value. For example, New Jersey offers SRECs for every 1,000 KWH of electricity. In March 2006, the cumulative weighted average price ($/MWH) for an SREC was $201.98 on the open market. See http://www.njcep.com/srec/trading-statistics.html. Therefore, the receivables include any valuable payment, instrument or other valuable consideration for the power generated by CPE 10. The receivables may be provided by a utility or other entity for power (electricity) generated by CPE 10 (and delivered onto a power grid 32).

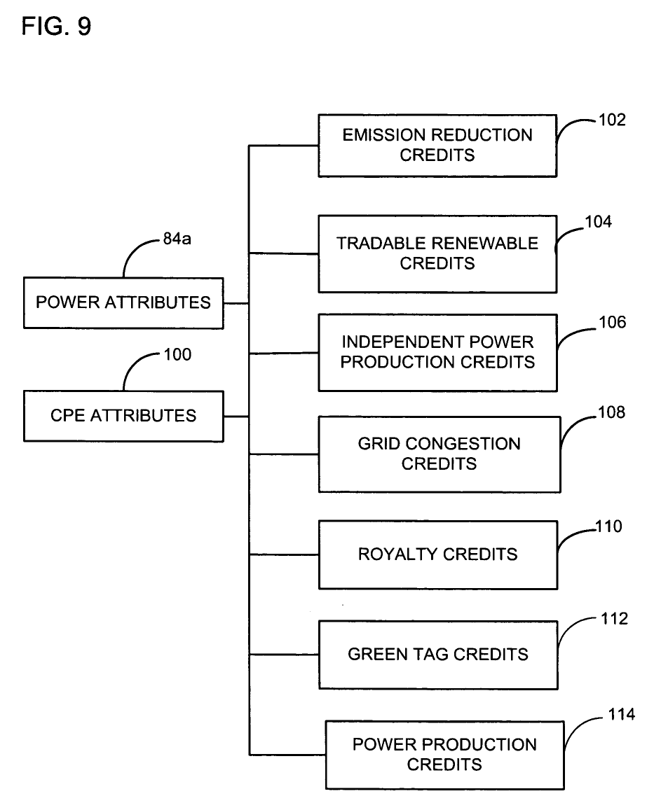

Referring to FIG. 4, the value of power (excess or direct gross power of the CPE 10) generated at step 52 of FIG. 3 is broken down in detail in routine A. As will be appreciated, the method (steps) of FIG. 4 is only one suitable embodiment for accomplishing the estimation of step 52. At step 52a, power generated by CPE 10 is estimated (estimated power generated is referred to as “EPG”). Step 58a may be accomplished through any suitable process such as by the steps in routine E shown in FIG. 10.

Turning to FIG. 10, seasonal factors affecting CPE 10 power generation are determined at step 58a1. In brief, the seasonal strength of sunlight and length of sunlight hours affect estimated power generation by CPE 10. These factors vary throughout the year (by season). Estimated power generation typically peaks during the summer and dips lowest during the winter. In some cases, this graphical function may be inverted (colder weather sometimes increases the power generation.). However, power generation depends on the angle (orientation discussed below) of the solar equipment (panels) as well as the weather conditions at the particular location.

Continuing with FIG. 10, Execution moves to step 52a2 wherein the CPE 10 location based factors affecting seasonal power generation are determined. The longitude and latitude placement of the CPE structure are factors that will be considered (or alternatively the zip code that can be translated into longitude and latitude). At step 52a3, the CPE 10 location based factors are used to determine weather based factors that affect power generation. That is, the specific placement of the CPE will affect power generation. For example, the CPE may generate greater power in the winter than in the summer depending on the particular placement (attachment) of the CPE 10.

With further reference to FIG. 10, at step 52a4, the degradation of power (based on the components of CPE 10) is determined. In other words, the efficiency of CPE 10 over the life of the CPE 10 is determined. Typically, efficiency decreases over the economic lifetime of the CPE 10. Many solar systems are warranted by their manufacture at their rated generation capability for 10-20 years (factory guaranteed output rating). With some CPE, the initial efficiency may be located above the manufacturer's rated capacity (100%). Average efficiency for CPE 10 will likely decrease linearly over time. There are also industry standards for degradation that may be considered in place of the manufacture's warranty. Also note that different system components may have different degradation rates and lives. These factors are also considered. Following step 52a4, other factors affecting power generation are determined at step 52a5. Such factors include panel type and the directional orientation of the CPE 10 (including degree of roof slope). The directional orientation includes the angle measure with respect to horizontal, vertical, or other reference plane such as ground or the surface on which the CPE is positioned. These factors also include sunlight concentration striking the CPE (due to water reflection, presence of concentrators or concentrating photovoltaics and/or coatings for example), sunlight blockage (e.g., a bush, tree, building, presence of residue of films of materials deposited from the air or from water and/or other element obstructing light from striking the CPE 10), expected sunlight at the CPE 10 over a given period of time and/or generation capacity of the CPE 10. There are other considerations affecting power generation including temperature limits of the solar modules, dirt, dust and plant material accumulation, mismatch and wiring losses, and DC to AC conversion losses.

If the factors in 52a1-5 are taken into consideration, estimated power generation can be determined accurate enough for lending purposes. See “A Guide to Photovoltaic (PV) System Design and Installation,” Edecon Engineering, Version 1, Jun. 14, 2001 for additional factors and their effect on CPE generation. Of course, those skilled in the art will recognize that certain of these steps may not be included in the process, and/or may be performed optionally on a case by case basis.

Returning to FIG. 4, following step 52a, the market buy back price (sold back to the power grid) for estimated power generated (EPG) is estimated at step 58b. In general, the buy back price will vary with the region, utility and market trading for power. In one example, market price may be maintained at a relatively high value for a given period of time and decreases to a low value. The price mildly increases following that decrease. In another example, market price may appear as a linear function over time wherein the market price steadily increases over time. See futures markets for power and discussion below. In sum, the buy back price may vary over time. The buy back price may be based on current market prices, scheduled PUC prices, future estimate market prices, wholesale prices, the amount of the power generated, timing of the power generated, and/or location of power generated.

Then, at step 52c, the monetary estimated value of the EPG by CPE 10 is calculated over the life of the loan by multiplying the EPG by market buy back price. This calculation may be performed using an equation such as (or alternatively another similar equation):

$$\$ EPG value = {\int }_{0}^{t} {EPG}_{t} \times {PG}_{t}$$

where “EPG” is the estimated power generated at a specified “t” time and “PG” is the buyback price of the power ($KWH) at a given time “t”. Following this calculation, execution moves to step 52d wherein estimated power consumption (EPC) is determined. EPC varies constantly because demands vary constantly due to changing consumer usage. Current usage (or consumption) is affected by the number and type of devices used by the consumer. For purposes of calculation, estimated consumption may be a fixed average value or varying values based on historical usage, cost of living, by location or other factors.

At step 52e, the market price (purchase from power grid) of power consumed is estimated. The market price of power will also vary and will depend on the geographical region, the entity selling the power, the arrangement (non-interruptible or interruptible contract) and time of day of use. Any given utility for example may set prices differently per season. In one example, the utility price for usage may remain constant over a period of time. Alternatively, the price may change based on a tiered (i.e., stepping) scheme over a given time period for a specific utility. California is an example of a State in which such a pricing scheme is used. In particular, usage price steps up incrementally after a certain amount of usage (over time).

In yet another example, utility price (daily) point maybe lower during off-peak periods. However, the price jumps to a higher level during peak periods of usage. Note that there might be more than one peak or non-peak rate. In yet another example, a different pricing scheme exists for consumers under “non-interruptible” and “interruptible” arrangements with a utility. In particular, the price per KWH is higher (for some real market prices) for consumers that do not accept interruptions in usage during peak usage periods. Alternatively, consumers that accept interruptions in power (due to peak usage, transmission congestion or other factors), the utility prices are substantially lower.

Rates are typically determined by the applicable regulatory agencies (PUCs) over a large period of time (e.g., 10 year or 20 years). The pricing component or gradient may be based on the consumer price index (CPI) for energy or may be derived from the futures commodity market for electricity proxies such Dow Jones electricity indexes (http://www.djindexes.com/mdsidx/?event=energyUSDaily) or natural gas futures market or other. In addition, any length of time may be used that is sufficient to enable the lender to determine long range pricing. (Price for power has historically increased 2-6% per year.) It is important for the lender to consider long-term pricing of power. While pricing is normally set by the PUCs, they will tend to mirror the projected long-term futures market for energy. Such information will help determine whether the customer can afford the repayments over the length of the loan. That is, the lender will determine whether there will actually be cash flow back to the lender over the long-term.

In sum, the consumer pricing scheme may be based on scheduled PUC prices, current market prices, future estimated market price, the presence or an absence of an interruption contract, the amount of power used, location of power used and/or the timing of the power used.

At step 52f, estimated monetary value of consumption (EPC) is calculated over the life of the loan. This calculation may be accomplished using the equation (or alternatively a similar equation):

$$\$ EPC value = {\int }_{0}^{t} {EPC}_{t} \times {PC}_{t}$$

where “EPC” is the estimated power consumption in dollars at a given time “t” and PC is the purchase price of power (from the utility or other entity that sells power) at a given time “t.”

Now, once the monetary values for EPG and EPC are calculated, the estimated net monetary value of power is calculated at step 52g in FIG. 4. This calculation is accomplished by the equation:

EPG−EPC=Net value for excess power.

### This value will be used to determine the financing or loan amount awarded and other financing or loan terms.

As described above, the loan amount awarded, interest rate, etc. are determined at step 58. As part of that determination, the routine B shown in FIG. 5 is performed to accomplish this task (along with information of steps 52-56). In particular, the lender shall continually review current market rates at step 58a to determine the rate at which the lender may borrow money. Such information will be obtained from a database of current market rates. The rate at which the lender may borrow will ultimately allow the lender to determine the rate at which the lender may then lend money to a consumer. At step 58b, the lender will determine the proper interest rate for the loan provided to the consumer based on the market interest rates for obtaining the money to loan the consumer.

Reference is now made to FIG. 6 wherein routine C is executed (as part of step 58). That is, the loan value (and terms) will take into an account any legal and other costs associated with collection should the consumer/borrower default on the financing or loan. These legal and other costs may include seizure costs and professional CPE service costs. In particular, at step 58c, the gross salvage or liquidation value of CPE 10 will be estimated and factored into the loan determination at step 58c. At step 58d1, the net salvage value of the CPE 10 is determined. As part of this step 58d, legal costs associated with the collected property will be subtracted from the gross salvage value. In addition, remarketing costs for CPE 10 resale will be subtracted from the gross salvage value of the CPE at substep 58d2. These costs are factored into the loan equation at step 58. In addition to these factors, there are costs for servicing the loan over the life thereof and other administrative overhead costs for processing the loan. These factors are determined at steps 58e and 58f.

At the same time as the steps of routines B and C are performed, or any other suitable time, to ultimately make a determination about loan terms, the consumer's application information shall be reviewed for fraud. In addition, the effective monetary value of CPE 10 is estimated. Rebates, credits, other subsidies and labor costs are determined and subtracted from the gross value of the CPE 10. The gross costs of the CPE 10 are typically provided by a solar installation professional/contractor or may be obtained from a database from invoice information. The estimate provided by the professional will likely include actual costs for the equipment and the professional costs for installation. Rebates are based on the state in which the CPE will be positioned.

Returning to FIG. 3, once step 58 is executed wherein the loan award amount is determined along with the terms thereof, the consumer's application is approved and the loan is offered to the consumer at step 60. Execution then moves to step 62 wherein the consumer accepts the loan. Now, once the loan package (defined) is determined, offered and accepted by the consumer (steps 58, 60, 62), a financial instrument shall be created supporting the loan or financing for the CPE 10. In an effort to increase the likelihood that the loan will be repaid, as part of the terms of the loan, the lender has the option to (1) secure the loan against personal and/or real property, at step 64 (routine D shown in FIG. 7) and/or (2) receive an assignment of the receivables at step 66 (alternatively or in addition take or receive an assignment in the other power proxy elements (besides the receivables), CPE attributes, a power purchase agreement, power contract and/or a conditional sales contract (all discussed below)). If the lender decides to secure the loan against personal and/or real property, a security interest(s) as discussed below shall be created as part of the financial instrument. If the lender chooses to receive an assignment of the receivables (unsecured loan), the lender will require that the consumer/borrower execute an agreement which, among other things, assigns the rights in the receivables to guarantee the loan. The same holds true for any assignment in other power proxy elements, power attributes, CPE attributes, a power purchase agreement, power contract and/or a conditional sales contract (all discussed below).

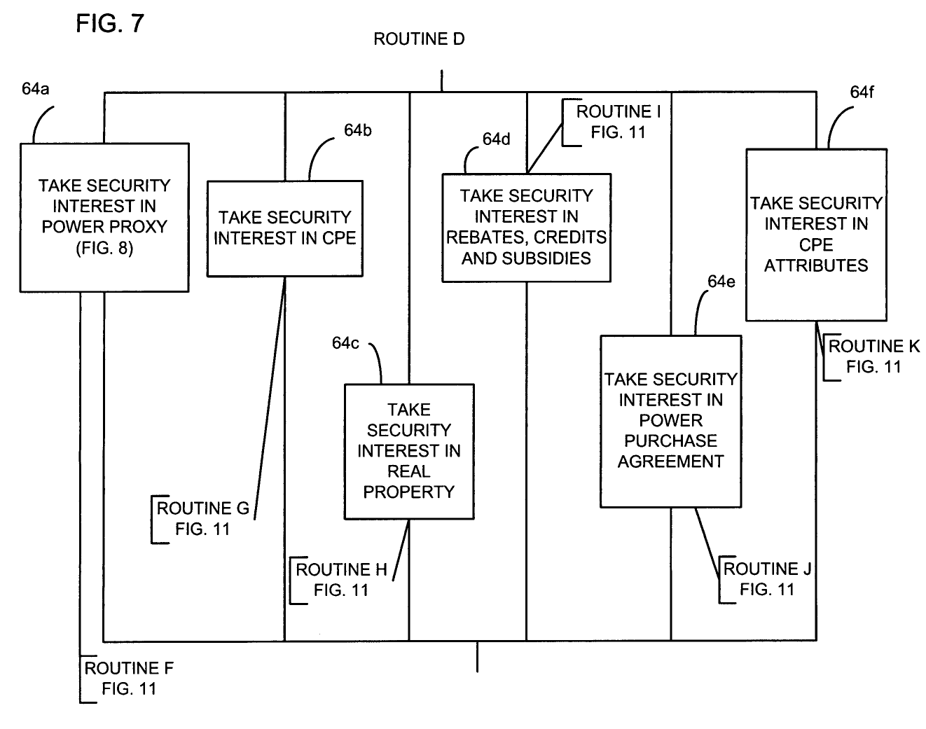

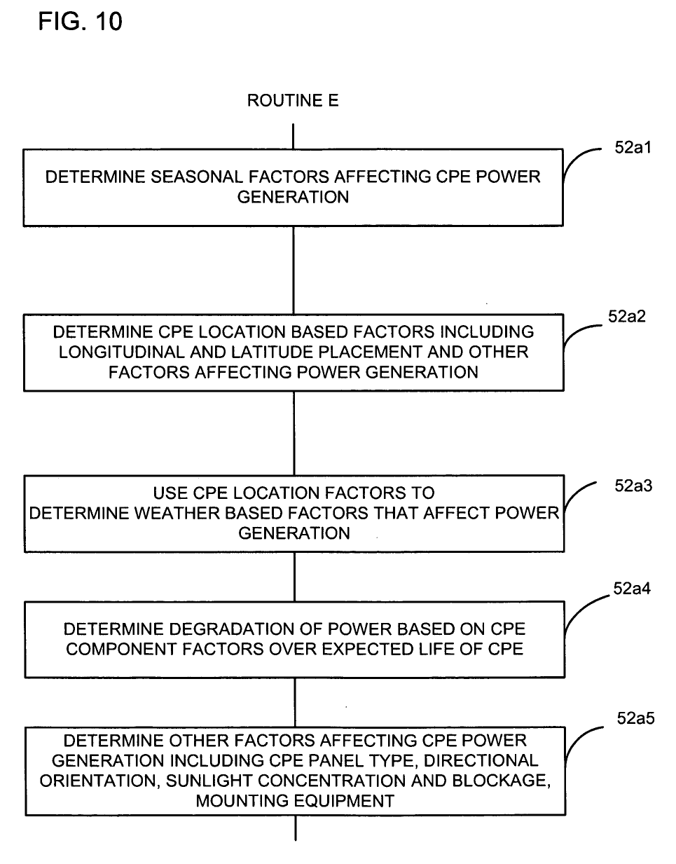

If the lender chooses to secure the loan against the personal property and/or real property as discussed below, the lender may follow the steps set forth in routine D in FIG. 7. In particular, at step 64a, the lender will take a security interest in the power proxy 80 as detailed in FIG. 8. Details of securing the power proxy are described with reference to routine F in FIG. 11. In addition to the security interest in the power proxy 80, the lender may take a security interest in the CPE 10 at step 64b (raw equipment as opposed to the attributes of the CPE 10 as described below) as well as in the real property on which CPE 10 is expected to be disposed at step 64c. Details of securing the CPE 10 and real property are described in routines G and H, respectively, in FIG. 11.

In addition or alternative to the security interests discussed thus far, the lender may take a security interest in the rebates, credits and any subsidies associated with the purchase of the CPE 10 and any power purchase agreement at steps 64d and 64e, respectively. The steps for securing the property in these steps are defined in routines I and J, respectively in FIG. 11. Lastly, the lender will likely take a security interest in the attributes associated with the CPE 10 at step 64f as defined in routine K in FIG. 11. The lender may secure the loan for the CPE 10 by taking a security interest in one or more of the power proxy (elements in FIG. 8), CPE, real property, rebates, credits and subsidies, power purchase agreement, and CPE attributes as set forth in steps 64a-f.

As stated above, the security interests discussed above (one or more) will be created as part of the financial instrument between the lender and the borrower/consumer. The financial instrument may include one note supporting the entire balance or a portion of the loan (financing) for the CPE 10. Alternatively, the financial instrument may include a plurality of notes supporting a plurality of amounts of the loan (financing) for CPE 10 wherein the sum of the amounts equals the balance of the loan or alternatively is less than the balance of the loan. In the embodiment in which a plurality of notes are used, such plurality of notes may be cross-collateralized whereby a default by a consumer on one or more notes (of the plurality of notes) triggers a default by the consumer on any or all of the remaining notes. Alternatively, the plurality of notes may not be cross-collateralized whereby a default by the consumer on one note will not trigger a default by the consumer on the remaining notes (of the plurality of note under the financial instrument).

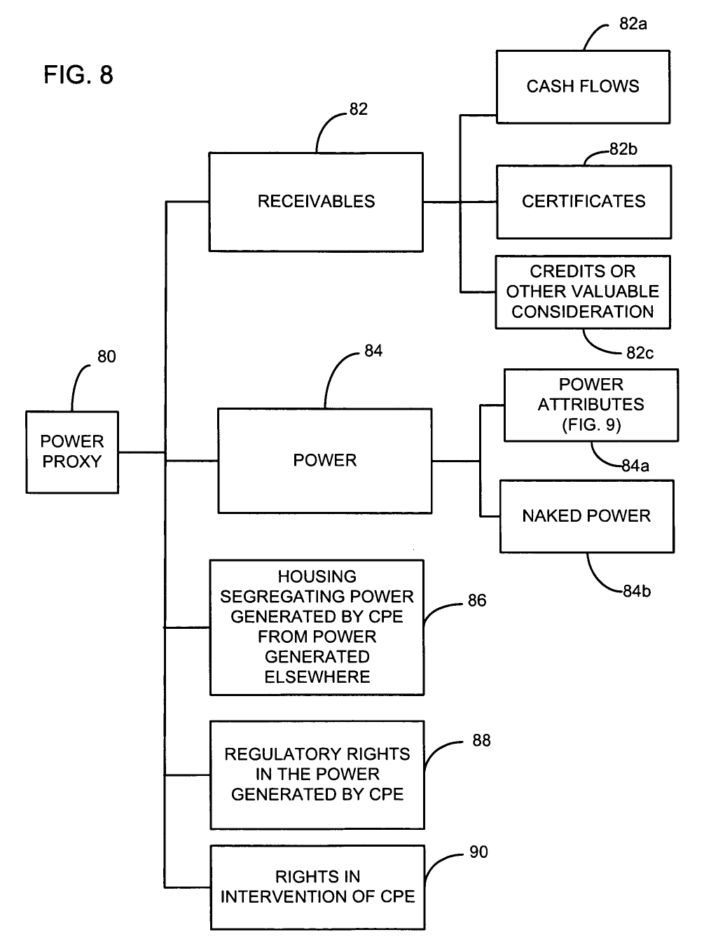

Reference is now made to FIG. 8 wherein examples of the power proxy 80 are shown. In particular, power proxy 80 includes receivables 82, power 84 and housing 86. Receivables 82 may be cash flows 82a, certificates 82b, and/or credits or other valuable consideration 82c for the power generated by the CPE 10. The receivables 82 may be provided by a utility or other entity that pays or reimburses a consumer for power generated by the CPE 10. Power 84 may be defined as power attributes 84a as set forth in FIG. 9 or naked power 84b. Power attributes 84a as defined in Appendix B are the characteristics of power that are transferable separate and apart from the actual naked power itself. Naked power is merely the electrons themselves. Housing 86 is used to segregate power (naked power) generated by the CPE 10 from power generated elsewhere (e.g., other consumer power or utility power). The housing 86 may be identified by warehouse receipts, bill of ladings, and/or other documents evidencing title to housing 86 including, without limitation, warranty registration and affixed serial numbers. Note that a security interest in the housing is also known as an administrative security interest.

Power proxy 80 also includes regulatory rights 88 in the power generated by the CPE 10. For example, a regulatory entity such as a State PUC with control over a utility can change the amount billed to the consumer. These charges are similar to those third party charges that can be added to phone bills. The penalty for default would be loss of service and/or collection efforts. Such regulatory rights 88 are created by debiting a consumer's bill for power generated by the CPE 10 or alternatively by updating a consumer record. Power proxy 80 further includes rights in intervention 90 of the CPE 10. That is, intervention rights is the ability (i.e., right) to interfere with the consumer's ability to use the CPE 10 to generate power. Such intervention may be by sending a person out to intervene or using a device (local or remote) to intervene.

Reference is now made to FIG. 9 wherein power attributes 84a and CPE attributes 100 are shown. The attributes (power and CPE) shown in FIG. 9 may be associated with either power and/or the CPE 10 (i.e., indistinguishable from power or the CPE 10). Therefore, the attributes are shown in the same figure (FIG. 9) as associated with both power 84 and the CPE 10. Power attributes 84a and/or CPE attributes 100 include emission reduction credits (ERC) 102. ERCs 102 (certificates) are assets that can be used by its owner or sold to entities that need emission (e.g., ROC, NOx, PM (including PM₁₀), CO or Sox) offsets. An emission offset occurs when an entity compensates for an increase in emissions in one area by decreasing emissions in another area. ERCs 102 are only issued for reductions of actual emissions that are quantifiable, enforceable, permanent and surplus. Typically, there is no minimum or maximum limit on the amount of reductions that may be eligible for ERC (certificates). Once the ERC (certificate) is redeemed, the ERC is retired, and cannot be used again. State or county entities ultimately determine the rules by which ERCs 102 are issued and redeemed. Suffice it to say, the ERC system is both good for business and good for the air. ERCs 102 also means earning goodwill in the community.

Power attributes 84a and/or CPE attributes 100 may also include tradable renewable credits (TRCs) 104. TRCs 104 shall mean any and all awards, credits and/or other consideration representing the value for the attributes associated with power generated by a renewable energy (“green”) source. These attributes can be unbundled (i.e., separated) from the underlying power itself (naked power) and sold independently as one or more discrete, tradable instruments to entities that value “greenness.”

In detail, TRCs (green tags) are a market mechanism that represent the environmental benefits associated with generating power (electricity) from renewable energy sources. Rather than functioning as a tax on pollution-causing electricity generators, as traditional carbon emissions trading programs do, TRCs function as a non-governmental subsidy on pollution-free electricity generators. In states which have a TRC program, a TRC energy provider (such as a wind farm or a consumer with CPE) is credited with one TRC for every 1000 kWh of electricity it produces. A certifying agency gives each TRC a unique identification number to make sure it doesn't get double-counted. The TRC or green energy is fed into the electrical grid (by mandate), and then the accompanying TRC can be sold on the open market.

Power attributes 84a and/or CPE attributes 100 also include independent power production (IPP) credits 106 and grid congestion credits 108. IPP credits 106 shall mean the value in aggregating individual consumer power generation and selling aggregated power for more than the value of selling the components as un-aggregated power. In other words, IPP credits 106 may be aggregated or accumulated to attain the status of an IPP which afford that entity the opportunity to sell power at greater value than the value an entity may receive individually, for example, for selling power generated by CPE (e.g, below wholesale rates).

Grid congestion credits 108 are a mechanism that represents certain benefits associated with generating electricity from renewable energy sources and with relieving demand on the local power grid. Grid congestion continues to be a problem as the demand for power increases. Grid congestion credits 108 function as a credit or subsidy for a reprieve on local grid congestion.

Power attributes 84a and/or CPE attributes 100 may also include royalty credits 110. Royalty credits 110 means the cash flow associated with royalty interests. Royalty interests are payments made for the use of property such as the CPE 10. The payment amount is usually a percentage of revenues obtained through the use of the property. Royalty credits 110 may also include an option to purchase some or all of the CPE, a divided or undivided interest in the CPE, a right to receive a certain amount of the output power from the CPE and/or royalty interest in the CPE (as indicated earlier). Power attributes 84a and/or CPE attributes 100 also includes green tag credits 112. Green tag credits 112 are the same as tradable renewable credits 104. Power attributes 84a and/or CPE attributes 100 may also include power production credits 114 (also known as power purchase agreement or credits). Power production credits accrue when power purchase agreements are accumulated.

The power attributes 84a and/or CPE attributes 100 are credits that may include (identified by or associated with) federal tax credits, state tax credits, utility credits, third party credits, subsidies and/or rebates.

It should be note that a lender or consumer may sell the attributes (power attributes and/or CPE attributes) under different circumstances to reduce the amount financed.

In order to secure the loan as set forth in step 64 in FIG. 3, the lender may take security interests as set forth in routine D of FIG. 7.

Reference is now made to FIG. 11 wherein routines (F-K) for taking security interests in routine D (FIG. 7) are described in detail. In particular, the lender shall take a security interest in the power proxy 80 (i.e., power proxy security interest). There are two steps in routine F to accomplish this. First, the lender must attach the security interest to the collateral (power proxy elements in FIG. 8) at step 64a1. In other words, the security interest must be created by a financial instrument or other legal agreement document.

To create financial instrument or other legal agreement, the lender may require the consumer/borrower to execute such a financial instrument (UCC1 statement for personal property). The financial instrument will describe the collateral. In this case, the collateral includes one or more power proxy 80 elements shown in FIG. 8 (receivables 82, power 84, housing 86, regulatory rights in power generated by the CPE 88 and the rights in intervention 90). In short, the financial instrument gives the lender the authority to foreclose or make a claim to the collateral. The financial instrument will also include other terms including payment terms, what constitutes a default, the rights of the lender/creditor upon default, maintenance of the solar equipment, insurance for the equipment and possibly other terms, including but not limited to the right to assign the financial instrument by the lender.

Second, the lender must perfect the security interest to ensure that the lender has priority over other creditors of the collateral. This is accomplished at step 64a2. There may be different methods for perfecting different power proxy elements shown in FIG. 8. The category or characterization of the elements (e.g., “receivables”) will ultimately dictate the method of perfection (in accordance with State law). One common method used for perfection of the power proxy security interest (if such elements are characterized as personal property under state law) is filing a financing statement (UCC1 filing for personal property). In short, the statement shall include the name of the consumer (borrower/debtor), the name of the secured party/lender and the property covered by the statement. There are, however, exceptions to filing. Possession of the collateral is one of them. For purpose of a security interest in “receivables” (e.g., cash flow security interest), the filing method for perfection would apply because “receivables” are likely characterized as personal property under relevant State law (UCC). On the other hand, “regulatory rights in the power generated by the CPE” may likely be characterized differently (see below for example).

In the event a filing is required, the lender shall follow the laws of the State to determine the proper office for filing. The most common office to file is the Secretary of State. In other situations, the recording office for filing is the county in which either the collateral or debtor is located. The location for filing varies by State and the type of collateral. For example, in California, the proper location for filing is the Secretary of State unless the security is a motor vehicle for which the proper location is the Department of Motor Vehicle. In Virginia, the proper location for filing is Virginia State Corporation Commission office of the Clerk. In Maryland, the proper location for filing is the Maryland Department of Assessments and Taxation. Article 9 of the UCC dictates the rules and requirements for taking security interests in personal property. All States have adopted Article 9 of the Uniform Commercial Code (UCC), but some have exceptions (e.g., filing). (Chattel mortgages may alternatively be used as a vehicle for security interests described herein if permitted by an individual State.).

An example of attachment and perfection is now described with respect to the regulatory rights in the power generated by the CPE (element of power proxy). In particular, attachment may take the form of a bill or invoice with the added charges representing the loan payments. Perfection in this case would be the possession of a copy of the bill or invoice which listed additional charges. The charges will be added to the balance or charged against any credit on the invoice. A copy of the bill with the additional charges in the possession of the lender shall give the lender superior rights over the consumer's payments against third parties.

Another example of attachment and perfection is described for a security interest in the housing 86 segregating power generated by the CPE from power generated elsewhere. Creating the security interest in the housing may include identifying the housing in the financial instrument by a warehouse receipt(s), bill of lading or other document evidencing title of the housing. Perfection may include possession of the warehouse receipts, bill of lading or other document evidencing title.

In addition to the security interest in the power proxy 80, under the terms of the arrangement with the consumer, the lender shall also take a security interest in CPE 10 (CPE security interest) as set forth in step 64b. To this end, a CPE security interest will be created by the financial instrument. In reality, the lender will do this because the lender wishes to ensure that (1) the CPE (as an asset) continues to generate power in order to garnish the benefits from the CPE and (2) the lender will be repaid upon the sale of the property in the event the consumer/borrower defaults. The security interest documents such as the financial instrument may permit the lender to place additional restrictions on the use, maintenance and insurance as well as restriction on the removal or sale of the CPE.

As for the process, the same UCC requirements equally apply to the CPE (provided that the CPE constitutes personal property as opposed to real property). CPE security interest must be attached (created) and perfected as set forth in steps 64b1 and 64b2 of routine G in FIG. 11. Under the terms of the arrangement (financial instrument), the lender will be also be authorized to foreclose or make a claim to the collateral (CPE) described in the financial instrument. Similar to the power proxy security interest, the agreement will also include payment terms, default terms, lender/creditor terms upon default, CPE maintenance terms and insurance requirements. The agreement is likely to be State specific and take into consideration such elements as “one right of action” rules.

In addition to attachment, the lender must perfect the CPE security interest to ensure that the lender has priority over other creditors of the collateral. This is accomplished at step 64b2. Perfection will likely be accomplished by filing a UCC1 statement (UCC1 filing for personal property). In short, the statement shall include the name of the borrower/debtor, the name of the secured party/lender and the property covered by the statement. In this case, the property is CPE. In the event a filing is required under applicable State law, the lender shall follow the State laws to determine the proper office for filing. As indicated above, the most common office to file is the Secretary of State. In other situations, the recording office for filing is the county in which either the collateral or debtor is located. The location for filing varies by State and the type of collateral.

Note that for security interests in personal property, the UCC filing is typically active for a period of five years unless continued for an additional five years at a time. The UCC filing will lapse at the expiration of the five-year period unless a continuation statement is filed, typically within six months prior to the date of lapse.

In addition to the security interests in the power proxy (e.g., receivables/power and CPE), the lender may secure the loan against the real property/estate on which the CPE will be attached. Much like the terms for the CPE, a security interest in the subject real property (real property security interest) will be attached and perfected (steps 64c1 and 64c2 of routine H in FIG. 11). The conventional real property/estate documents will be signed to attach (create) the interest to the real property. Such documents typically include the mortgage papers. Real property/estate papers (financial instrument) are typically separate from the documents (financial instrument) relating to the power proxy security interest and CPE security interest. However, all security interest documents may be evidenced by one universal financial instrument (provided such instrument abides by State law.)

If required, a deed will transfer to the lender or trustee and then be recorded along with the mortgage documents in the appropriate office for perfection. The real property documents are typically recorded in the county or local office in which the real property is located. The CPE will also be subject to and recorded as part of real property/estate. Once filing is performed, the transaction is secured against third parties. There is no need for further action on the part of the lender unless there is a default. The recorded documents remain of record until the lender is repaid the full amount of the loan. At this time, the mortgage documents will be returned to the consumer/borrower.

In the event a consumer has a conditional sales contract for the real property, the lender may take a security interest in the conditional sales contract (attachment and perfection).

Note that one real value to the consumer in securing the loan against the real property is the tax benefit. The consumer/borrower should receive tax deductibility treatment from the IRS and/or other taxing bodies for the interest on real property mortgage. As an alternative to a mortgage, a deed of trust may be used to secure the payment of the loan.

In accordance with the invention, the lender has now attached and perfected (i.e., filing) the CPE as personal property as well as part of the real property. There is a real advantage in following this process. The dual filings ensure that the public is placed on notice of the rights in the CPE against any third party interests. Since under State law there may exist some uncertainty whether CPE constitutes personal or real property, in accordance with the invention, the lender shall now record the CPE as personal property in the appropriate office of the Secretary of State (for example) and will record the CPE along with the real property in the appropriate county office. In this respect, the lender's interest in the CPE against any third party interests as well as bankruptcy or insolvency proceedings has been adequately protected. With respect to any type of property secured (described above), security interest documents may require a notary for creation of such documents.

In addition to the power proxy, CPE and real property security interests, the lender may secure the loan by taking a security interest in the rebates, credits and subsidies offered by the Federal, State and possibly local governmental entities for the CPE 10 at step 64d (California Solar tax credits are one type of rebate/subsidy). Steps 64d1 and 64d2 of routine I (FIG. 11) describe attachment and perfection of such rebates, credits and subsidies. The interest will be created by a financial instrument (agreement) which will describe the collateral (rebates, credits and subsidies) and authorized foreclosure or make a claim to the collateral. The financial instrument (agreement) will also include payment terms, default terms, lender/creditor terms upon default, CPE maintenance terms and insurance requirements. The financial instrument (agreement) is likely to be State specific and take into consideration such elements as “one right of action” rules.

In addition to attachment, the lender must perfect the security interest in the rebates, credits and subsidies to ensure that the lender has priority over other creditors of the collateral. Perfection will likely be accomplished by filing a financing statement (UCC1 filing for personal property) in the appropriate place or office dictated by State law. In short, the statement shall include the name of the borrower/debtor, the name of the secured party/lender and the property covered by the statement. State law will dictate the characterization of the subject property and the rules and requirements for attachment and perfection.

In addition the security interests described, the lender may take a security interest in a power purchase agreement (the actual agreement between the consumer and power provider to reimburse, credit or otherwise pay a consumer for power generated by the CPE). The security interest may be created by a financial instrument (alone or with other security interests described herein). Attachment and perfection are accomplished in steps such as steps 64e1 and 64e2 of routine K, respectively in FIG. 11. State law will dictate the characterization of the subject property (i.e., power purchase agreement) rules and requirements for attachment and perfection. The lender may also take a security interest in any power contract between resident consumer and a utility.

In addition to the security interests above, the lender will likely secure the loan against the CPE attributes (similar to power attributes under power proxy shown in FIG. 8). Attachment and perfection are set forth in steps 64f1 and 64f2, respectively. In particular, the security interest in CPE attributes will be created by a financial instrument and the security interest shall be perfected in accordance with State law. For the CPE attributes (like power attributes), such property may likely fall into the category of personal property and be perfected in accordance with the UCC (e.g., UCC1 filing).

In addition to the security interests above, the lender may take a security interest in (1) any assignment discussed above, including for example, the receivables or other power proxy elements and/or (2) any long term lease of the CPE and/or real property on which the CPE is disposed, and/or any chattel mortgage for the CPE. Attachment and perfection shall abide by State law for personal and real property.

In accordance with the present invention, the method for financing discussed above and the creation of these financial instruments may establish a market for creating and trading of such financial instruments. This market may include CPE installers which market services by introducing consumers to financing options through the plurality of financial instruments and brokers who facilitate the formation of the plurality of financial instruments.

Once all desired security interests are attached and perfected, execution of the method in FIG. 3 is complete. At this point, the lender may execute a check and forward it directly to the installer or other such suitable party. The check may be made for the entire amount or payment may be made incrementally. A first incremental payment may be made, for example, as a deposit for the materials. Another example may be an order or delivery of the materials/components that triggers a first incremental payment. Subsequent incremental payments could be made upon passing an inspection of the installation (at job site by any entity including a government entity, a private provider of traditional governmental service including power, sewage entities, or the consumer even). Under another financing scheme/model, payment alternatively could be made to a distributor, a dealer or a manufacturer of the components of the CPE. Payments to these entities in an incremental scheme will help reduce fraud and will also ensure that the money is actually used to purchase and install the CPE in accordance with the requirements set forth in the financing application process.

When the consumer/borrower defaults on his/her obligations to repay the loan, the lender as a secured party has the rights and remedies provided in the security agreement, provided by the State UCC and other laws as well as provided in the mortgage documents. In general, the lender may reduce his/her claim to judgment, foreclose or otherwise enforce the security interest(s) by any available judicial procedure. The rights and remedies may be cumulative. In the embodiment of the present invention, the lender, in case of a default, will focus attention on the secured collateral. In this case, the collateral is the one or more power proxy 80 elements (FIG. 8), the CPE 10, and the underlying real property on which the CPE is attached, rebates, credits and subsidies, power purchase agreement, CPE attributes (like power attributes as part of power proxy) and/or any other property secured. However, the real property is not required for collection. The lender has other vehicles to ensure loan repayment including, for example, the power proxy including the receivables, power and the CPE itself. Therefore, the process for foreclosure is greatly simplified. With a simpler, less costly foreclosure procedure the risk premium associated with these loans is minimized. The reduced process is discussed below in more detail.

Now, a loan for the purchase of CPE may be repaid using several different methods under the terms of an agreement with the consumer/borrower. Under a traditional loan terms, the consumer repays incrementally during the life of a loan much like any loan (e.g., mortgage). The payments are typically made in monthly increments. Payments may be initially applied toward interest with the remaining monies applied toward the principal of the loan if the loan is fully or partially amortized. The consumer may make prepayments to the lender to be applied toward the principal with and without penalties. While this traditional payment method has been adequate, there exists an improved repayment method that would increase the likelihood that the lender's loan will be repaid and/or increase the lender's profits and/or reduce the cost of the loan to the consumer/borrower.

By following the steps of the method set forth in FIG. 3 (including the routines in later Figs.) in accordance with an embodiment of the present invention), the entire lending underwriting standards (and process for such standards) have been simplified (modified) and the costs have been reduced for the consumer. The process is now more streamlined (reduced) than the typical process for obtaining a traditional mortgage for the subject real property. In the traditional process, the lender will undertake an appraisal evaluation, a title search and other administrative functions.

In accordance with an embodiment of the invention, limited/abbreviated or no appraisals, property inspections or title searches will be conducted. There is no need for these functions when the lender takes into consideration other factors to repay the loan such as the receivables, rebates, credits, and subsidies, value of the CPE itself (for example). Such factors considered are used to modify, for example, the income-to-debt ratio and the debt service coverage of the lending underwriting criteria. In addition, such factors may be taken into consideration to show an increase in appraisal value of the real property (if an appraisal is actually performed). In other words, sufficient security exists in the personal property and other non-real property being secured (e.g., receivables in the power proxy, CPE, CPE attributes, the rebates and credits, etc.) as well as through use of credit information and any fraud verification.

Because there is no need for such evaluations, title searches and other administrative functions, the lending process is simplified and the costs relating to financing are reduced. Escrow requirements have also changed in view of the considerations above (security interests discussed as an example). In sum, the mechanisms used for underwriting enabling and escrow enabling take into consideration many factors (described above) to modify the lending underwriting standards as well as the fees associated therewith.

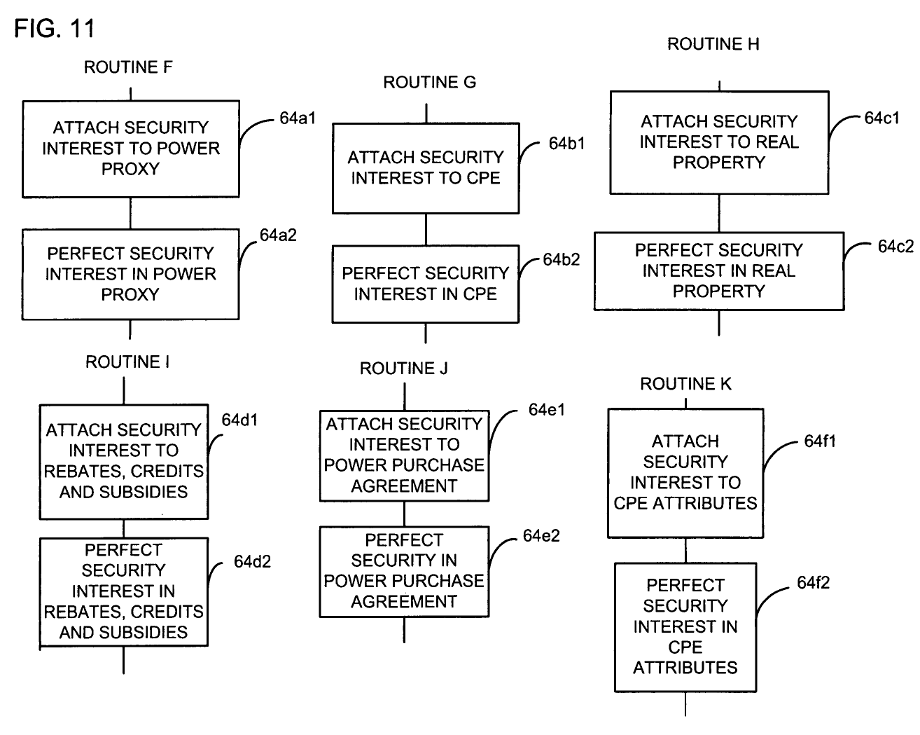

Another aspect of the invention is now described. In this aspect, the lender shall receive payments directly from a utility for the power (excess or directly off of the CPE) generated by the CPE and delivered onto the power grid. In such an arrangement, the utility shall purchase the power and distribute payments (process receivables) to the lender directly. The payments processed shall correspond to power measured at set increments. The consumer/borrower will continue to pay the utility for power (electricity) consumed. FIG. 12 illustrates an implementation of this method in accordance with an embodiment of the invention. It is assumed that the consumer has applied for a loan, and the lender has completed the steps of the method shown in FIG. 3. That is, the lender has offered and the consumer/borrower has accepted the loan at specified terms. At this point, the utility will measure or read the power consumed or generated by the consumer on a power measuring devices such as a meter (e.g., meter 30 shown in FIG. 12 at step 100. These measurements or readings are performed incrementally over a period of time (periodic power measurements). Most utilities perform readings on a monthly basis. However, the meter may be read at other increments including, but not limited to, weekly, daily, hourly or other interval or period of time-based readings (limited only by the physical meter measurement constraints, regulatory constraints, and automatic meter measurement constraints).

Depending on the meter used, the power read may be the excess power generated by the CPE (power generated that exceeds the power used by the consumer) or gross power directly off of the CPE. Traditional dial meters are commonly employed today for reading power consumption. In many cases, the utility bills a consumer for the amount of power used since the previous meter reading. Many of these meters, however, are capable of net metering.

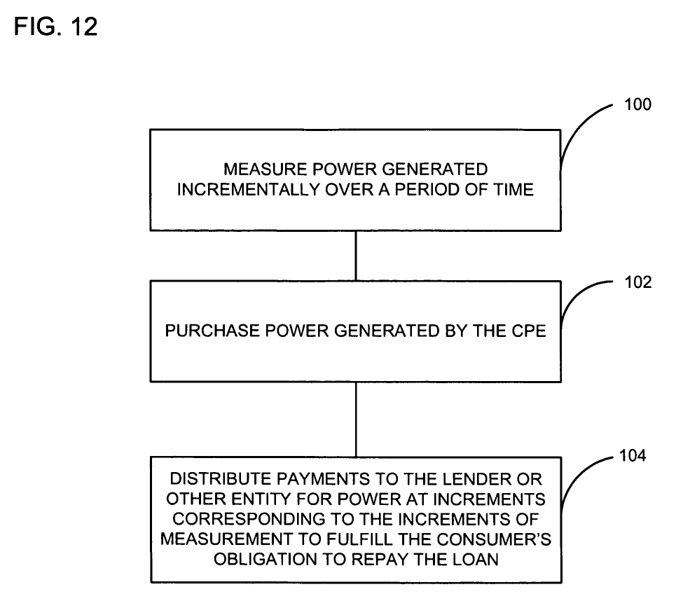

There are also bidirectional (or dual meters as discussed below) that can simultaneously keep track of power (electricity) consumed and power generated by the CPE. In some cases, dual meters are employed. One meter is used for measuring the flow of power (electricity) into the building from the utility and the other is used for measuring the flow of power out of the building (generated by the consumer). With dual metering only, the power generated is used as collateral. The consumer might pay the power company directly for the gross power they use from the utility. FIG. 13 illustrates an example of power consumed in a dual metering setting. P₁-P_{N} is the power read on the meter at T₁-T_{N} times, respectively. Note the different price values P₁, P₂, P₃ . . . P_{N} for times T₁, T₂, T₃ . . . T_{N}.

Smart metering systems such automatic meter reading (AMR) systems enable the utility to measure a consumer's power consumption remotely as well as more frequently than manual readings at a lower cost. Smart metering systems allow the utility to communicate between a meter interface module and a central office via a communications system. Communication may take the form of a telephone, power line carrier, radio frequency, internet, cellular or cable television.

Returning to FIG. 12, regardless of the method of meter reading (manually or remotely using smart systems), power measurements are taken incrementally over a period of time. The period may be any desired time interval, and power generated by the CPE is purchased by the utility or other entity at step 102. The power may be the excess power or gross power directly measured from the CPE 10 as discussed above. In the event of net-metering (one meter), net power consumed at any increment of time (over a period of time) will have a negative value. Excess power generated measured at any given increment of time (over a period of time), however, will have positive values. The polarity of this convention may be switched.

As stated above, at step 102, the power generated by the CPE and delivered onto the power grid is transferred to, converted and/or purchased by the utility. A billing mechanism may be used to determine on a periodic basis any value of the power generated by the CPE 10 (excess or directly off of the CPE 10). (There may also be a financing mechanism for identifying any rebates, credits and/or subsidies for the purchase of the CPE 10.) The purchase may be in the form of credit, certificate (e.g., New Jersey), cash or security representing value for the power.

Following step 102, the utility will distribute payments to the lender directly (or alternatively the consumer pays the lender directly as discussed below) to fulfill the consumer's obligation to repay the loan at step 104. Specifically, the billing mechanism provides payments or credits the value for the power generated by the CPE to the lender or other entity for financing of the CPE (financing discussed herein is used to mean loan for CPE purchase but it may also mean purchase, lease, installation and/or maintenance of the CPE 10). Payments will be made at increments corresponding to meter reading increments. In the current situation, the increments are made on a monthly basis. However, the meter reading frequency (period or increments) may vary as desired (e.g., weekly, daily, by minute or other time). While it is possible to increase the frequency of meter reading using current manual methods, smart metering (or remote meter reading) can make this function more practical and economical.

In an alternative embodiment, the consumer may pay the lender directly or the consumer pays the lender or through a servicing agent. A servicing agent is a third party that collects money and interfaces with the consumer. In yet another alternative embodiment, the consumer may pay the lender directly until there are payment issues (i.e. the consumer is late with payments), and then the utility may step into the process and pays the lender directly.

In accordance with the present invention, the step of securing the loan against the receivables would effectively mean that the security interest would be a right in the receivables generated in accordance with the frequency readings (e.g., on a monthly, daily or other unit of time basis). Alternatively, in the event the lender chooses to be paid conventionally (paid by the consumer), the receivables may be garnished at the frequency rate of the meter readings (in the event of a default).

As indicated above, the method of FIG. 3 and related FIGS. 4-13 were described in terms of a loan for purchase. However, the present invention contemplates a variety of financing techniques for a variety of activities including purchase, lease, installation and/or maintenance of the CPE 10. It is also noted that the method of FIG. 3 may be computer implemented, manually implemented or a combination of computer and manual implementation.

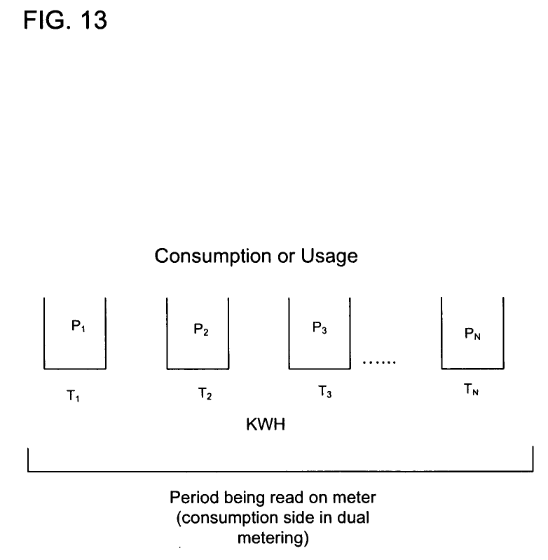

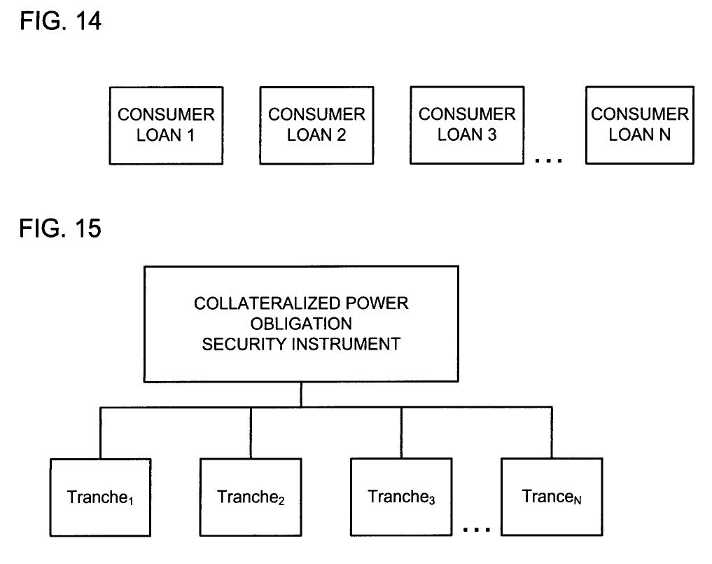

Reference is made to FIGS. 14 and 15 wherein another embodiment of the present invention is shown. The method employs a collateralized power obligation (CPO) for the cash flow from groups or pools of individual loans described above with respect to FIG. 3. As an example, one group of pooled loans is shown in FIG. 14 (LOAN #1, LOAN #2, LOAN #3 . . . LOAN #N). A CPO is similar but not identical to a CMO (collateralized mortgage obligation), CDO (collateralized debt obligations) or mortgage pass through security. In this embodiment, a security is backed by its ownership of the pool of the individual loans (offered in FIG. 3). This security or instrument is secured by the cash flow of the pool of individual loans as well as ownership in the underlying pool of individual loans.

In the CPO (in brief), the regular principal and interest payments made by borrowers (consumers) could be separated into different payment streams, creating several bonds that repay invested capital at different rates, with different terms. In short, the advantage of a CPO is that the original lender keeps the loans on their books only for a short time. The loans are resold at a profit to the equity or debt investors whom will pay more for tranches than the sum is worth. A tranche is a class of security or ownership interest in a CPO offering. In a CPO, the original lender may become what is known as a packager. The packager might only hold the individual loans temporarily. Similar to a warehouse line of credit, after a sufficient amount of loans are accumulated to create a CPO, the loans are conveyed to a trust or entity that owns the underlying loans for the benefit of investors that own an interest in various cash flows.

The consumer/borrower will likely pay the loan in installments composed of both interest and principal. Over the life of the loan, the interest component of payments, which typically comprises a majority of the payments in the early years, gradually declines as the principal component increases. To obtain funds to make more loans, original lenders or packagers either “pool” groups of loans with similar characteristics to create securities or sell the loans to issuers of securities. The securities created from pools of loans are essentially “pass-through securities.” Pass-through securities or bonds represent a direct ownership interest in a pool of loans or the trust or entity that holds these pools of loans. As the consumers whose loans are in the pool make their loan payments, the money is distributed on a pro rata basis to the holders of the securities.

In accordance with the present invention, CPOs offer investors a wider range of investment time frames and greater cash-flow certainty than had previously been available. As indicated above, the CPO issuer assembles a package of these pass-through securities or bonds and uses them as collateral for a multiclass security offering (as described above) such as tranches. The CPO structure enables the issuer to direct the principal and interest cash flow generated by the collateral to the different tranches in a prescribed manner, as defined in the offering's prospectus, to meet different investment objectives.

The cash flow from the CPO collateral may be allocated in a variety of ways. Usually, it is first allocated to meet the interest obligations on all tranches in the offering. Principal repayments, both scheduled and prepaid, are then distributed to the different classes of bondholders according to a predetermined priority schedule which is outlined in the CPO prospectus or offering circular. The tranche receiving principal repayment is referred to as “active” or “currently paying.” In more complex structures, more than one tranche can be paying principal at a time. In addition, there may be fees associated with tranches. Also, different tranches may have difference credit ratings based on risk assessed.

Each CPO tranche has an estimated first payment date, on which investors can expect to begin receiving principal payments, and an estimated last principal payment (or maturity) date, on which they can expect their final dollar of principal to be returned. The period before principal payments begin in the tranche, when investors receive interest-only payments, is known as the “lockout” period. The period during which principal repayments are expected to occur is called the “window.” Both first and last principal payment dates are estimates based on prepayment assumptions and can vary according to actual prepayments made on the underlying mortgage loans. These pass-through securities may typically appeal to investors with a certain investment horizon.

As seen in FIG. 14, several payment streams with varying amounts, interest rates and other conditions are shown (Loan #1-Loan #N). FIG. 15 illustrates the CPO with several tranches (Tranchesₓ). In general, the CPO may have several arrangements including a fast-pay bond with a maturity much shorter than the total pool, a bond paying interest only for a period that may be fixed on some condition, and a bond paying variable interest based on an index such as LIBOR, the Prime Rate or an index based upon US Treasury bills, notes and bonds. Regardless of the bond arrangement, the CPO backed by the type of financial instruments discussed in this application will have lower risk of default than an individual loan. The bonds will be secured against or collateralized by the power proxy, CPE, credit, rebates and subsidies for CPE, CPE attributes and/or the real property on which the CPE is attached (as defined above).

The CPO described above may have two unique tranches in accordance with two different embodiments of the invention. In accordance with one embodiment, one tranche represents future power/CPE attributes including emission reduction credits or tradable renewal credits. As part of the contract with the consumer, consumers will assign to the lender any future carbon credits or renewal energy credits (for example). These credits may be sold in the future in any market that develops for them.

In accordance with the second embodiment, another tranche represents the value that might accrue because of the scale or size of the CPO allows the CPO to become a larger IPP. In this respect, the CPO may have the right to become a power marketer with the right sell power on the open market. Open market value is usually much higher than the prices offered by the utilities based on PUC dictated pricing. The two different embodiments of the tranche arise from assignable rights that the consumer will convey to the lenders.

While the embodiments of present invention described in this application are applied to property in the U.S., the methods may apply in any jurisdiction (US or foreign).

It should be noted that the lender described herein may be any entity including a bank, finance company, individual or other entity that is legally authorized to lend money or advance funds. It should also be noted that the embodiments of the method (of the present invention) above applies to solar energy. In alternative embodiments, however, any renewable energy source may be used that generates electricity (that can be valued). Many utilities will purchase electricity from a number of sources including wind, biomass and hydroelectric (in addition to solar). The sources of energy can be either renewable or non-renewable.

In summary, the embodiments of the methods described herein offer opportunities for financing the purchase of CPE and other financial rewards that are either not offered by or do not suffer from the disadvantages of the prior art.

The foregoing description of the embodiments of the invention has been presented for purposes of illustration and description. It is not intended to be exhaustive or to limit the invention to the precise form disclosed and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

APPENDIX A

| | | | | % of | | |
|---|---|---|---|---|---|---|
| | | | | institutions | | |
| | | 2003 | 2003 | charging | 2003 | 2001 |
| | Definition | Highest | Lowest | (2003) | Average | Average |
| LENDER/BROK | | | | | | |
| ER FEES | | | | | | |
| Administration fee | This is a fee charged by | $600 | $325 | 14% | $336 | $413 |
| | other lenders to cover some | | | | | |
| | of their expenses. It can | | | | | |
| | range from zero to several | | | | | |
| | hundred dollars. | | | | | |
| Application fee | The fee charged by the | $350 | $200 | 18% | $205 | $266 |
| | lender to the borrower for | | | | | |
| | applying for a loan. A fee | | | | | |
| | usually paid at the time an | | | | | |
| | application is given to a | | | | | |
| | lender for helping to | | | | | |
| | complete and review an | | | | | |
| | application. Payment of this | | | | | |
| | fee does not guarantee that a | | | | | |
| | loan will be approved. | | | | | |
| Commitment fee | Any fee paid by a potential | $660 | $295 | 2% | $498 | $268 |
| | borrower to a lender for the | | | | | |
| | lender's guarantee to lend | | | | | |
| | money at a specified rate | | | | | |
| | and within a specified time | | | | | |
| | period. | | | | | |
| Document | This is a separate fee that | $400 | $25 | 34% | $194 | $162 |
| preparation fee | some lenders or title | | | | | |
| | companies charge to cover | | | | | |
| | their costs of preparation of | | | | | |
| | final legal papers, such as | | | | | |
| | mortgage, deed of trust, note | | | | | |
| | or deed. | | | | | |
| Funding fee | A fee paid for a loan. used | $375 | $200 | 14% | $228 | $126 |
| | to identify the fee paid to | | | | | |
| | the VA for issuing their | | | | | |
| | guarantee. Also may be | | | | | |
| | applied to an additional fee | | | | | |
| | paid for funding a | | | | | |
| | conventional loan, typically | | | | | |
| | a commercial loan, at | | | | | |
| | closing. | | | | | |
| Mortgage broker | A charge, usually measured | $1,161 | $150 | 46% | $839 | $344 |
| or lender fee | by points, made by the | | | | | |
| | mortgage broker for | | | | | |
| | originating the loan. | | | | | |
| | Included in closing costs. | | | | | |
| | Same as loan origination fee | | | | | |
| | for a bank. | | | | | |
| Processing fee | Processing involves | $595 | $37 | 45% | $320 | $303 |
| | validating customer | | | | | |
| | information and | | | | | |
| | coordinating third-party | | | | | |
| | findings so that an | | | | | |
| | underwriter can make a | | | | | |
| | decision to approve the | | | | | |
| | application. Once approved, | | | | | |
| | loan documents can be | | | | | |
| | drawn and the closing can | | | | | |
| | be scheduled. | | | | | |
| Tax Service fee | A search of the Registry of | $100 | $60 | 82% | $73 | $72 |
| | Deeds for the county in | | | | | |
| | which the property lies is | | | | | |
| | conducted to confirm that | | | | | |
| | taxes on the property are | | | | | |
| | paid in full and up to date. | | | | | |
| | Any unpaid property taxes | | | | | |
| | are a liability to the lender. | | | | | |
| Underwriting fee | Underwriting covers the | $749 | $100 | 40% | $269 | $280 |
| | costs of assessing an | | | | | |
| | applicant's qualifications for | | | | | |
| | a mortgage loan. | | | | | |
| Wire transfer fee | When your loan funds, it is | $45 | $15 | 50% | $31 | $55 |
| | a common practice for a | | | | | |
| | lender to wire the funds to | | | | | |
| | the settlement provider | | | | | |
| | (escrow holder, title | | | | | |
| | company, or attorney). This | | | | | |
| | is a fast and efficient way to | | | | | |
| | transfer funds in a | | | | | |
| | transaction where time is | | | | | |
| | crucial. The receiving a | | | | | |
| Subtotal | | $5,035 | $1,407 | | $2,993 | $2,290 |
| THIRD-PARTY | | | | | | |
| FEES | | | | | | |
| Appraisal fee | This charge covers an | $600 | $250 | 83% | $327 | $269 |
| | appraisal report made by an | | | | | |
| | appraiser. | | | | | |
| Settlement: | This fee pays for the | $1,423 | $50 | 93% | $445 | $374 |
| Escrow/Attorney | services of the escrow or | | | | | |
| | settlement agent who | | | | | |
| | handles all the financial | | | | | |
| | transfers, plus payments | | | | | |
| | associated with the | | | | | |
| | transaction. In some states, | | | | | |
| | an attorney performs the | | | | | |
| | functions of an escrow | | | | | |
| | agent, in which case this fee | | | | | |
| | is in pl | | | | | |
| Credit report fee | This fee covers the cost | $55 | $8.50 | 81% | $29 | $37 |
| | your lender incurs in | | | | | |
| | obtaining a copy of your | | | | | |
| | credit report. Your credit | | | | | |
| | report shows your credit | | | | | |
| | history, and the lender uses | | | | | |
| | this information to help | | | | | |
| | decide whether or not to | | | | | |
| | approve your loan and how | | | | | |
| | much money to lend you. | | | | | |
| Flood certification | This fee covers the cost | $25 | $10 | 95% | $17 | $22 |
| fee | (normally $10–$30) of a | | | | | |
| | report to determine if the | | | | | |
| | property is in a flood-risk | | | | | |
| | area as determined by The | | | | | |
| | Federal Emergency | | | | | |
| | Management Agency | | | | | |
| | (FEMA). If your home is | | | | | |
| | located in one of these flood | | | | | |
| | zones, you will be required | | | | | |
| | to secure insurance. | | | | | |
| Pest & other | Termite and residence | $200 | $30 | 8% | $68 | $86 |
| inspection fees | inspection. | | | | | |
| Postage/courier fee | A charge for the costs of | $100 | $25 | 81% | $45 | $45 |
| | sending documents to | | | | | |
| | various parties using | | | | | |
| | couriers or express mail | | | | | |
| | services. These costs are | | | | | |
| | generally based on actual | | | | | |
| | usage and will generally be | | | | | |
| | higher when the process is | | | | | |
| | rushed, but some lenders | | | | | |
| | may use a fixed charge. | | | | | |
| Survey fee | fee charged for an expert | $400 | $50 | 28% | $174 | $227 |
| | examination of the property | | | | | |
| | you are considering buying, | | | | | |
| | aimed at discovering any | | | | | |
| | structural flaws or repairs | | | | | |
| | needed which you may have | | | | | |
| | failed to notice yourself. | | | | | |
| Title insurance fee | Insurance which protects the | $2,075 | $50 | 83% | $605 | $460 |
| | lender (lender's policy) or | | | | | |
| | the buyer (owner's policy) | | | | | |
| | against loss due to disputes | | | | | |
| | over ownership of a | | | | | |
| | property. | | | | | |
| Title work | Title search, plat drawing, | $625 | $25 | 29% | $200 | $220 |
| | name search. | | | | | |
| Subtotal | | $5,503 | $499 | | $1,910 | $1,740 |
| GOVERNMENT | | | | | | |
| FEES | | | | | | |
| Recording fee | A non-tax fee for the cost | $220 | $23 | 99% | $76 | $72 |
| | of actually recording a | | | | | |
| | mortgage loan. | | | | | |
| City/county/state | A tax which some localities | $6,750 | $22.50 | 33% | $1,339 | $558 |
| tax | collect when a mortgage | | | | | |
| stamps/intangible | loan is recorded. It can be | | | | | |
| tax fee | significant and is set by state | | | | | |
| | and/or local governments. | | | | | |
| Subtotal | | $6,970 | $46 | | $1,415.00 | $630 |
| OTHER FEES | | | | | | |
| Reconveyance fees | A recorded document that | | | | $45 | |
| | shows a previous loan has | | | | | |
| | been paid in full. | | | | | |
| Notary fees | This fee covers the cost of | | | | | |
| | having a person who is | | | | | |
| | licensed as a notary public | | | | | |
| | swear to the fact that the | | | | | |
| | persons named in the | | | | | |
| | documents did, in fact, sign | | | | | |
| | them. | | | | | |
| Total | | $17,508 | $1,951 | | $6,318 | $4,659 |
| All the estimates | | | | | | |
| were based on a | | | | | | |
| $180,000 loan to | | | | | | |
| an applicant with | | | | | | |
| good credit who | | | | | | |
| makes a down | | | | | | |
| payment of at least | | | | | | |
| 20 percent on the | | | | | | |
| purchase of a | | | | | | |
| single-family | | | | | | |
| residence. | | | | | | |
| http://www.bankrate.com/brm/ | | | | | | |
| news/mortgages/20031106b1 | | | | | | |
| and | | | | | | |
| http://www.bankrate.com/brm/news/ | | | | | | |
| mtg/20010621b.asp | | | | | | |

### Appendix B

### Terms and Definitions

“administration fee” shall mean the fee charged by lenders to cover some of their expenses. The fee can range from zero to several hundred dollars or more.

“administrative security interest” shall mean a security interest in the housing containing power. This security interest is created by administrative means, not specified by the Universal Commercial Code (UCC). This may include administratively segregating all the power generated over a specific time so that any one lender has a unique claim or security interest in a set amount of power.

“amount of power generated” shall mean the quantity of power produced by a consumer's CPE. The amount of power generated is typically qualified over a specific time period.

“amount of power used” shall mean the quantity of power used or consumed by a consumer. This is the same as the amount of power consumed.

“application fee” shall mean a fee charged by the lender to the borrower for applying for a loan. The application fee is usually paid at the time an application is given to a lender for helping to complete and review an application. Payment of this fee does not guarantee that a loan will be approved.

“appraisal fee” shall mean the charge covering an appraisal report made by a third-party appraiser.

“appraisal value” shall mean a monetary assessment or valuation of the property appraised.

“appraisal” shall mean the act of estimating or judging the value of something including, without limitation, personal property, real property, CPE or other property.

“assignment” shall mean a transfer of any right, interest and/or title in something of present or future value including, without limitation, receivables, cash flow and payment streams.

“attributes” shall mean the power attributes and/or the CPE attributes.

“automatic meter reading” shall mean the technology of automatically collecting data from energy meters and transferring that data to a central database for billing and/or analyzing.

“balance of the loan” shall mean the amount of unpaid principal on a specific note or notes.

“bill of lading” shall mean any legal document between a shipper of a particular good and the carrier detailing the type, quantity and destination of the good being carried. The bill of lading also serves as a receipt of shipment when the good is delivered to the predetermined destination. This document must accompany the shipped goods, no matter the form of transportation, and must be signed by an authorized representative from the carrier, shipper and receiver. In the context of this application, a bill of lading is any document evidencing the transmission of power from the consumer's CPE to the utility.

“bonds” shall mean a financial instrument with which the investor (lender) loans money to an entity that borrows the funds for a period of time at a specified interest rate. The indebted entity issues investors a certificate, or bond, that states the interest rate (coupon rate) that will be paid and when the loaned funds are to be returned (maturity date).

“cash flow” shall mean a revenue or payment stream that changes a cash account over a given period. Cash flow can also be defined as the monetary value of the power generated by the CPE over a specified period of time.

“cash flow security interest” shall mean a security interest in cash flow.

“chattel mortgage” shall mean a loan to buy some personal item or good, the item or good being used as security for the loan.

“city/county/state tax stamps/intangible tax fee” shall mean the tax which some localities collect when a mortgage loan is recorded. It can be significant and is set by state and/or local governments.

“collateral” shall mean any property or asset pledged by a borrower to secure a loan or other credit, and subject it to seizure in the event of default. Collateral shall include any real or personal property including, without limitation, receivables.

“collateralized power obligation” (also known as “CPO”) shall mean a financial instrument or security that is secured by its ownership of a pool of individual loans for the purchase of CPE. This security or instrument is secured by the cash flow of the pool of such individual loans as well as ownership in the underlying pool of individual loans.

“commitment fee” shall mean any fee paid by a potential borrower to a lender for the lender's guarantee to lend money at a specified rate and within a specified time period

“computer implementation” shall mean the execution of any or all process steps by computer.

“conditional sales contract” shall mean a contract for the sale of a property or an asset where the buyer has possession and use, but the seller retains title until the conditions of the contract have been fulfilled.

“consumer” shall mean a user or purchaser of power (electricity).

“consumer lending laws” shall mean any and all state and federal law enacted to protect the consumer from certain illegal lending practices. Usury laws and predatory lending laws are examples of consumer lending laws.

“consumer premises equipment” (also known or referred to as “CPE,” “renewable energy consumer premises equipment,” and “renewable energy CPE”) shall mean any thing or characteristic of the consumer premises equipment (CPE) including, without limitation, CPE attributes and the physical assets of the CPE (i.e., naked CPE). CPE shall include any and all renewable energy equipment (as the physical assets or naked CPE) purchased or owned by a consumer that resides or is disposed on or near a residential building or business, institution or other real property. CPE also includes any and all mounting equipment. CPE may also be referred to as Consumer Power Equipment or Consumer Premises Owned Equipment.

“CPE attributes” shall mean attributes or characteristics of the CPE that are transferable separate and apart from the actual physical assets of the CPE. CPE attributes may also be referred to as attributes.

“CPE security interest” (also referred to as a “CPE physical asset security interest” or “consumer premises security interest”) shall mean a security interest in the CPE.

“consumer protection laws” shall mean any and all state and the federal enacted laws to protect the consumer (the retail purchasers of goods and services) from inferior, adulterated, hazardous and deceptively advertised products, and deceptive or fraudulent sales practices. Consumer lending laws are a subset of consumer protection laws.

“consumer risk of default” shall mean the risk that a consumer will fail to make payments on a loan.

“consumer's credit information” (also referred to as “consumer credit information”) shall mean any information relating to the credit granted to a consumer permitting the use or ownership of goods or services during a term of payment. In the context of this application, this means information that underwrites the granting of a consumer a loan to purchase CPE. Credit information includes, but is not limited to, a consumer's FICO score.

“CPE factory guaranteed output ratings” shall mean the guaranteed ratings of CPE performance power generation by the manufacture of the CPE over the period of the warranty for the CPE.

“credit report fee” shall mean the cost that a lender incurs in obtaining a copy of a credit report. The credit report shows credit history, and the lender uses this information to help decide whether or not to approve a loan and how much money to lend.

“credits” shall mean any money or other valuable consideration offered to an entity for certain defined acts. Credit is based on the character of the borrower, the cash flow of the borrower and the collateral pledged (if any) by the borrower.

“cross-collateralized” shall mean a situation in which one or all notes supporting a loan are considered in default merely if one of the notes is in default.

“current market price” shall mean the last reported sale price of a financial instrument, security or other tradable commodity or the current bid and ask prices of the security or other tradable commodity.

“dealer” shall mean an entity who sells CPE from a distributor to an installer or directly to the consumer.

“debt-service-coverage ratio” is a ratio used by lenders in underwriting how much money to loan to a consumer. This ratio should ideally be over 1, which would mean that the consumer is generating enough income (net of expenses) o pay its debt obligations. The debt-service-coverage ratio is calculated by dividing the net operating income by total debt service. For purposes of this application, income is income net of expenses such as payments for utilities.

“deed of trust” shall mean a document which pledges real property to secure a loan by a consumer. The property is deeded by a title holder (trustor) to a trustee (often a title or escrow company), which holds the title in trust for the beneficiary (the lender of the money). When the loan is fully paid, the trustor requests the trustee to return the title by reconveyance. If the loan becomes delinquent or is in default, the beneficiary can file a notice of default and, if the loan is not brought current, the trustee can demand that the trustee begin foreclosure on the property so that the beneficiary may either be paid or obtain title.

“default” shall mean the failure to make a payment when due, which can lead to a notice of default and the start of foreclosure proceedings if the debt is secured by real or personal property.

“degradation as estimated by industry standards” shall mean an estimate of the gradual failing or loss of power generation of the CPE based on industry standard relationships of power generated over time.

“degradation as implied by the warranty” shall mean an estimate of the gradual failing of the CPE (loss of power generated) as implied by the warranty of the CPE.

“degradation of the CPE” shall mean the gradual failing or loss of power generated from the CPE over time.

“divided interest” shall mean an ownership interest in only a part of a property. The interest in the selected part may be total or partial.

“distributor” shall mean an entity who sells CPE to an installer or a dealer.

“document preparation fee” shall mean a separate fee that some lenders or title companies charge to borrowers cover their costs of preparation of final legal papers, such as mortgage, deed of trust, note or deed.

“dual metering” shall mean the use of two power measuring meters, one meter being used for measuring power consumption by the consumer and the other being used for measuring power generation by the CPE.

“emission reduction credits” (also known as “ERC”) shall mean any award, grant or “credit” that is provided to an entity for the reduction of emissions or pollutants into the air by implementing more stringent controls than required by a permit or an applicable regulation.

“entity” shall mean any person, group of persons, company, division, agency, partnership or other entity (private or government). Entity includes, without limitation, an installer, dealer, manufacture and distributor of the CPE.

“escrow” shall mean any documents, real property/estate, money, or securities deposited with a neutral third party (the escrow agent) to be delivered upon fulfillment of certain conditions, as established in a written agreement.

“excess power” shall mean the power generated by the CPE that exceeds the power consumed by the consumer. Excess power is also referred to as “net power.”

“expected net present value of net cash flows” shall mean the expected sum of the present values of the cash flows associated with a CPE and a consumer.

“expected sunlight” (at the CPE) shall mean the sunlight that is predicted to shine upon the CPE at a given period of time.

“federal tax credits” shall mean any credits offered by a Federal entity to a consumer to offset any income tax due.

“FICO score” (Fair Isaac Company score) shall mean the mathematical model that is used as a tool by lenders to evaluate the risk associated with lending to an entity money.

“financial instrument” shall mean any real or virtual document representing a legal agreement involving some sort of monetary value. Such financial instrument can be classified as equity based, representing ownership of the asset, or debt based, representing a loan made by an investor to the owner of the asset. Financial instruments shall include “notes.” Financial instruments are also known as securities.

“flood certification fee” shall mean the fee to cover the cost (normally $10-$30) of a report to determine if the property is in a flood-risk area as determined by The Federal Emergency Management Agency (FEMA).

“funding fee” shall mean a fee paid for a loan. The fee is used to identify the fee paid to the VA for issuing their guarantee. Also may be applied to an additional fee paid for funding a conventional loan, typically a commercial loan, at closing

“future estimated market price” shall mean an estimation of the market price of a commodity for example in the future. For the purposes of this application, it is the price that the consumer can sell (or buy) a certain amount of power at a certain point in time.

“future net cash flows” shall mean costs to maintain, and cash flows produced by power generated by the CPE.

“general obligation bond” shall mean a common type of municipal bond in the United States that is secured by a state or local government's pledge to use legally available resources, including tax revenues, to repay bond holders.

“generation capacity (CPE)” shall mean the maximum power a CPE can generate in a given period of time.

“green tag credits” (also known as renewable energy credits (RECs)) shall mean tradable renewable credits or certificates (TRCs)).

“grid congestion credits” are a mechanism that represents certain benefits associated with generating electricity from renewable energy sources. Grid congestion credits function as a credit or subsidy for a reprieve on local grid congestion.

“housing” shall mean any protective cover designed to contain or support something tangible including, without limitation, electricity. The housing segregates the electricity (for example) contained in the housing from other electricity.

“housing security interest” shall mean a security interest in a housing.

“income-to-debt-ratios” is a calculation of a person's monthly payments (minimum credit card payment, student loans, car loan, and in some circumstances, rent/mortgage) in proportion to your gross monthly income. For the purpose of this application, utility bills are monthly payments.

“independent power producer” shall mean any entity that generates electricity and then sells the power in wholesale markets (e.g., California's PX)

“independent power production credits” shall mean the value in aggregating individual consumer power generation and selling it for more than the value of selling it as un-aggregated power.

“installer” shall mean any party that installs CPE for a consumer.

“interest” shall mean the fee that is charged by a lender to a borrower for the use of borrowed money, usually expressed as an annual percentage of the principal.

“intervention” means the ability (i.e., the right) to interfere with a consumer's ability to use the CPE to generate power.

“intervention security interest” means a security interest in the rights in intervention in the CPE

“investors” shall mean any entity that commits money to investment products, financial instrument or security with the expectation of financial returns.

“late fees” shall mean any money assessed for failing to pay an amount due by a specified period of time.

“latitude” shall mean the angular distance North or South from the Earth's equator measured in degrees on the meridian of a point.

“lending underwriting criteria” shall mean any and all credit information (1) furnished by the borrower (consumer) including employment history, salary and financial statements, (2) publicly available information including the borrower's credit history, which is detailed in a credit report, (3) the lender's evaluation of the borrower's credit needs and ability to pay and the consumer's credit score.

“lending underwriting standards” shall mean the principles by which the lending underwriting criteria shall be judged in connection with the repayment of a loan.

“lending underwriting” shall mean or refer to the detailed rules and credit analysis preceding the granting of a loan. Such analysis includes a thorough review of lending underwriting criteria.

“loan amount” shall mean the amount of money offered to a consumer for the purchase of property including, without limitation, the CPE.

“loan” shall mean an arrangement in which a lender gives money to a borrower (the consumer), and the borrower agrees to return the property or repay the money, usually along with interest, at some future point(s) in time. Generally the lender has to bear the risk that the borrower may not repay a loan. A loan is evidenced by a specific financial instrument (or financial instruments).

“longitudinal (longitude)” shall mean the angular distance between a point on any meridian and the prime meridian at Greenwich.

“long-term lease” shall mean a lease whose term is enough time from initial signing until the date of expiration or renewal option that is qualifies for tax deductibility.

“manually implementation” shall mean the performance of any method or steps of a method by manual means (human).

“manufacturer” shall mean any entity that builds and/or assembles a product. For the purpose of this application, a manufacture is the producer of some or all of the CPE.

“market interest rates” shall mean the rate of interest paid on deposits and other investments, determined by the interaction of the supply of and demand for funds in the money market.

“mixed manually and computer implementation” shall mean the performance of a method or one or more steps thereof by both manual (human) interaction and computer execution.

“mortgage broker or lender fee” shall mean a charge, usually measured by points, made by the mortgage broker for originating the loan. The fee is included in closing costs. The fee is the same as a loan origination fee for a bank.

“mortgages” shall mean a debt financial instrument by which the borrower (mortgagor or consumer) gives the lender (mortgagee) a lien on property as security for the repayment of a loan.

“naked power” shall mean electricity (i.e., electrons) separate and apart from the power attributes associated with the power. Naked power is measured in units such as Watts or Kilowatts.

“negative excess power” shall mean power generated exceeding the power consumed.

“negative consumed power” shall mean power used by a consumer in excess of the power generated by the CPE.

“net metering” shall mean a mechanism that is used as a utility resource usage and payment scheme in which a consumer who generates their own power is compensated monetarily for the excess of the power generated by the CPE over the power used by the consumer.

“net cash flow” shall mean the cash flows experienced by a consumer including the initial investment in a CPE, costs to maintain, and cash flows produced by power generated by the CPE.

“notary fees” shall mean the fee covering the cost of having a person who is licensed as a notary public swear to the fact that the persons named in the documents did, in fact, sign them.

“note” shall mean a financial instrument or debt security that matures on a date set forth in the note. A loan might consist of or be supported by one or more notes.

“orientation” shall mean the latitude and longitudinal coordinates of the CPE.

“ownership interest” shall mean any interest in a business as a shareholder in a company that carries on the business or partner in a partnership that carries on the business or the sole proprietor of the business, including interest held indirectly through one or more intervening companies, partnerships or trusts.

“payment streams” shall mean cash flow associated with a CPE.

“perfecting” is a means by which a lender establishes superior rights in collateral against any third parties.

“personal property” shall mean property of any kind except real property. Personal property may be tangible, having physical existence, or intangible, having no physical existence, such as financial instruments. Personal property shall include, without limitation, CPE, CPE attributes, rebates, credits subsidies, receivables and cash flow.

“personal property security interest” shall mean a security interest in personal property.

“pest & other inspection fees” shall mean the cost of termite and residence inspection.

“physical meter readings” shall mean meter readings performed manually.

“postage/courier fee” shall mean the charge for the costs of sending documents to various parties using couriers or express mail services. These costs are generally based on actual usage and will generally be higher when the process is rushed, but some lenders may use a fixed charge.

“pool of individual loans” shall mean a grouping of individual loans. The individual loans may consist of one or more notes. For the purposes of this application, the purpose of the loans is for the purchase of CPE.

“power” (also known or referred to as “electricity” or “energy”) shall mean any thing or characteristic relating to power, including, without limitation, power attributes and naked power.

“power attributes” shall mean the attributes or characteristics of power that are transferable separate and apart from the actual naked power itself. Power attributes are also referred to as attributes.

“power attribute security interest” shall mean a security interest in a power attribute.

“power contracts” shall mean a contract between the producer of power and a resident consumer of power.

“power grid” (also known as the “power transmission and distribution grid,” “electric grid” or “grid”) shall mean the network of transmission and distribution lines (and the step-up and step-down transformers) that is used to deliver electricity to consumers.

“power interruption contract” is a contract between a power generator and a consumer that allows the provider to interrupt power to the consumer during peak periods of demand in exchange for better electricity rates.

“power proxy” shall mean a representative of the monetary value of power generated (over a set time period). Power proxy shall include, without limitation, receivables, cash flow, power, regulatory rights in power generated by the CPE and intervention rights in the CPE.

“power proxy security interest” is a security interest in a power proxy.

“power purchase agreement” shall mean an agreement between a power provider and a consumer in which the power provider (e.g., utility) agrees to, among other things, reimburse, credit or otherwise pay a consumer for power generated by the consumer's CPE. Power purchase agreements typically involve a business consumer and extend for a long period of time.

“power security interest” shall mean a security interest in power.

“power usage or power consumed” shall mean power used or consumed over a period of time. Its units are Kilowatt-hours.

“principal” shall mean the amount of a debt on which interest is calculated.

“private activity bond” shall mean a bond for which more than 10% of bond proceeds are to be used directly or indirectly in a trade or business carried on by persons other than governmental units, and for which more than 10% of the debt service on the bonds is directly or indirectly secured by a private business.

“processing fee” shall mean fees involving validating customer information and coordinating third-party findings so that an underwriter can make a decision to approve the application.

“progress payments” shall mean payment made as work progresses or purchases are made under a contract.

“public utility commission” (also known as a PUC) is a regulatory body in every state in the U.S. that governs public utilities within its jurisdiction such as electricity, gas, oil, sewer, water, transportation and telephone service. Some states call it the Public Service Commission (PSC).

“real property” shall mean the land as well as any permanent fixtures on it including buildings, trees and other fixtures.

“real property security interest” shall mean a security interest in real property, including without limitation, consumer premises.

“rebates” shall mean a deduction from the amount due or a return of part of an amount given in payment.

“receivables” shall mean any payment, instrument or other valuable consideration owed to a consumer (or other entity) for the power generated by the CPE, whether or not such payment, instrument or other valuable consideration is currently due. The receivables may be provided by a utility or other entity. Receivables shall include, without limitation, any credit, money certificate or other quantifiable value for power generated by a CPE.

“receivables security interest” shall mean a security interest in receivables.

“reconveyance fee” shall mean fees for recording a document that shows a previous loan has been paid in full.

“recording fee” shall mean the non-tax fee for the cost of actually recording a mortgage loan.

“regulatory constraints” shall mean the constraints or rules imposed by a governmental entity.

“regulatory rights” shall mean any rights provided by a regulatory entity.

“regulatory security interest” shall mean any enforceable claim against a consumer that is created by debiting a consumer's bill.

“remarketing costs” shall mean the expenses incurred in the process of reselling foreclosed upon CPE.

“renewable energy” shall mean power supplied by energy sources that are naturally and continually replenished such as wind, solar power, geothermal, hydropower, and various forms of biomass.

“renewable energy source” shall mean sources of renewable energy such as water (hydroelectric power), wind, biomass and solar energy.

“resale of CPE” shall mean the act of selling the CPE again.

“revenue bond” shall mean bonds whose principal and interest are payable exclusively from earnings of a public enterprise.

“royalty credits” shall mean the cash flow associated with a royalty interest.

“royalty interests” shall mean a payment made for the use of property. The payment amount is usually a percentage of revenues obtained through its use.

“salvage value” shall mean the market value of a depreciable asset (e.g., CPE) at the time it is sold or removed.

“scheduled PUC prices” shall mean the prices planned by a PUC at specified times.

“securing” shall mean the step or steps of taking a security interest in collateral.

“securities” shall mean financial instruments.

“security interest” shall mean any interest in a property that secures the payment of an obligation. The property subject to a security interest is often times called collateral. Security interests shall include attaching the security interest in the collateral and perfecting the security interest.

“settlement: escrow/attorney fees” shall mean the fee that pays for the services of the escrow or settlement agent who handles all the financial transfers, plus payments associated with the transaction. In some states, an attorney performs the functions of an escrow agent.

“state recordation agency” shall mean the governmental entity of a State in which a record or other required document should be filed.

“state tax credits” are credits offered by a State to a consumer to offset any income tax due.

“subsidies” shall mean a monetary grant given by government to lower the price of a good such as CPE, generally because they are considered to be in the public interest.

“supporting a loan” shall mean character of a borrower, the collateral and associated cash flow.

“survey fee” shall mean the fee charged for an expert examination of the property, aimed at discovering any structural flaws or repairs needed.

“tax service fee” shall mean fees for a search of the Registry of Deeds for the county in which the property lies is conducted to confirm that taxes on the property are paid in full and up to date. Any unpaid property taxes are a liability to the lender.

“third party credits” shall mean credits provided to consumers by third parties.

“timing of power generated” shall mean the time at which power is generated by CPE.

“timing of power used” shall mean the time at which power is used or consumed by a consumer.

“title insurance fee” shall mean the fee for insurance which protects the lender (lender's policy) or the buyer (owner's policy) against loss due to disputes over ownership of a property.

“title insurance” shall mean the insurance that protects both the lender and the homeowner (borrower) against loss resulting from any defects in the title or claims against a property that were not uncovered in the title search and that are not specifically listed as exemptions to the coverage on the title insurance policy.

“title search” shall mean the process of examining all relevant records to confirm that the seller of a property is the legal owner of that property and that there are no liens or other claims outstanding.

“title work fee” shall mean the fees involving title search, plat drawing, name search and the like.

“tradable renewable credits” (also known as TRCs, renewable energy credits, RECs, renewable tradable certificates, green tags, green tag credits and green tickets) shall mean any and all awards, credits and/or other consideration representing the value for the attributes associated with power generated by a renewable energy (“green”) source. These attributes can be unbundled (i.e., separated) from the underlying power itself (naked power) and sold independently as a discrete, tradable instrument to entities that value “greenness.”

“traditional escrow requirements” shall mean any customary or conventional escrow requirements associated with a transaction involving real property.

“tranche” shall mean a class of security or ownership interest in a CPO offering.

“UCC1 filing” shall mean a UCC1 statement that is filed with the secretary of state or other designated public official under the Uniform Commercial Code (UCC). The document is time stamped, the filing date is noted, and a file number is assigned, securing the lender's claim to the assigned collateral.

“UCC1 statement” (also known as a financing statement) is a standard document under the Uniform Commercial Code, and this document is an agreement between a lender and borrower detailing, among other things, property taken as collateral from the borrower.

“underwriting fee” shall mean fees for underwriting. This covers the costs of assessing an applicant's qualifications for a mortgage loan.

“undivided interest” shall mean a complete or partial ownership of all parts of a whole. For example, an undivided interest in a pool of loans means the ownership or rights to a certain percent of each and every loan in the pool.

“usury laws” shall mean laws or regulations that prohibits a rate of interest on a debt that is exorbitant and in excess of the percentage allowed by law.

“utility” shall mean any entity that purchases, sells or markets power to (or from) the consumer of power or has the primary relationship with that consumer.

“utility credits” shall mean any credit offered by a utility, usually for public policy reasons.

“value of attributes of power generated” shall mean the monetary quantity assigned to the attributes of power generated by CPE.

“value of power attributes” shall mean the monetary quantity assigned to the power attributes of power generated by CPE.

“warehouse receipts” shall mean any document guaranteeing the existence and availability of a given quantity and quality of a commodity in storage for safekeeping.

“water reflection” shall mean the image of something as reflected by water. The image includes sunlight.

“wire transfer fee” shall mean the fee when a loan funds. It is a common practice for a lender to wire the funds to the settlement provider (escrow holder, title company, or attorney). This is a fast and efficient way to transfer funds in a transaction where time is crucial.

I claim:

1. A business method of financing renewable energy consumer premises equipment (CPE) for power generation at a consumer premises, the power generated having attributes that are transferable separate from naked power, the method comprising:
(a) defining at least one attribute associated with the power generated by the (CPE), wherein the at least one attribute is transferable separate from naked power; and
(b) securing financing for the CPE by taking a security interest in the at least one attribute associated with power generated by the CPE.

2. The method of claim 1 wherein defining the at least one attribute associated with the power generated by the CPE include one or more of:
(a) identifying emission reduction credits;
(b) identifying tradable renewable credits;
(c) identifying independent power production credits;
(d) identifying grid congestion credits;
(e) identifying royalty credits;
(f) identifying green tag credits; and
(g) identifying power production credits.

3. The method of claim 2 wherein the identified credits include one or more of:
(a) federal tax credits;
(b) state tax credits;
(c) utility credits;
(d) third-party credits;
(e) subsidies; and
(f) rebates.

4. The method of claim 2 wherein the identified credits exist now or will exist in the future.

5. The method of claim 2 wherein identified royalty credits include one or more of the following:
(a) an option to purchase some or all of the CPE;
(b) a divided or undivided interest in the CPE.
(c) a right to receive a certain amount of the output from the CPE; and
(d) royalty interests in the CPE.

6. The method of claim 1 wherein the security interest is associated with a mortgage and/or a deed of trust.

7. The method of claim 1 wherein the security interest is associated with a UCC1 filing.

8. The method of claim 7 wherein the security interest is further associated with a mortgage and/or a deed of trust.

9. The method of claim 7 wherein the security interest is further associated with one or more of the following:
(a) conditional sales contract;
(b) regulatory security interest;
(c) administrative security interest;
(d) assignment;
(e) long-term lease; and
(f) chattel mortgage.

10. The method of claim 1 wherein defining the at least one attribute associated with the power generated by the CPE includes identifying tradable renewable credits.

11. The method of claim 1 wherein defining the at least one attribute associated with the power generated by the CPE includes identifying royally credits.

12. A method of financing renewable energy consumer premises equipment (CPE) for power generation at a consumer premises, the CPE having attributes that are transferable separate from naked CPE, the method comprising:
(a) securing financing for the CPE by taking a security interest in the attributes associated with the CPE.

13. The method of claim 12 wherein the attributes associated with the CPE include one or more of the following:
(a) emission reduction credits;
(b) tradable renewable credits;
(c) independent power production credits;
(d) grid congestion credits;
(e) royalty credits;
(f) green tag credits; and
(g) power production credits.

14. The methods of claim 13 wherein the credits include one or more of the following:
(a) federal tax credits;
(b) state tax credits;
(c) utility credits;
(d) third-party credits;
(e) subsidies; and
(f) rebates.

15. The method of claim 13 wherein such credits exist now or will exist in the future.

16. The method of claim 13 wherein such royalty credits include one or more of the following:
(a) an option to purchase some or all of the CPE;
(b) an divided or undivided interest in the CPE;
(c) a right to receive a certain amount of the output from the CPE; and
(d) royalty interests in the CPE.

17. The method of claim 12 wherein the security interest is associated with one or more of the following:
(a) a mortgage;
(b) deeds of trust;
(c) a conditional sales contract;
(d) a UCC1 filing;
(e) a regulatory security interest;
(f) an administrative security interest;
(g) an assignment;
(h) a long-term lease; and
(i) a chattel mortgage.

18. The method of claim 12 wherein the security interest is associated with a mortgage and/or a deed of trust.

19. The method of claim 12 wherein the security interest is associated with a UCC1 filing.

20. The method of claim 19 wherein the security interest is further associated with a mortgage and/or a deed of trust.

21. A method of financing renewable energy consumer premises equipment (CPE) by a consumer for power generation at a consumer premises, the CPE having rebates, credits or subsidies associated therewith, the method comprising:
securing financing for the CPE by taking a security interest in rebates, credits and/or subsidies due.

22. The method of claim 21 wherein the rebates, credits and/or subsidies due are one or more of the following:
(a) California Solar Tax Credit;
(b) any state tax credit; and
(c) any Federal tax credit.

23. The method of claim 21 further comprising:
conveying an assignment in the rebates, credits and/or subsidies to an entity who finances the CPE.

24. A method of financing renewable energy consumer premises equipment (CPE) for power generation at a consumer premises, a power output of the CPE sold in a power purchase agreement, the method comprising:
securing financing for the CPE by taking a security interest in the power purchase agreement.

25. The method of claim 24 further comprising:
filing the power purchase agreement in one or more of the following locations:
(a) a relevant state PUC; and
(b) a relevant state property recordation agency.

26. A method of financing renewable consumer premises equipment (CPE) for power generation at a consumer premises, the power generated having attributes that are transferable separate from naked power, the method comprising:
(a) defining attributes of the power generated by the CPE that are transferable separate from naked power; and
(b) selling the attributes associated with power generated by the CPE to reduce an amount financed.

27. The method of claim 26 wherein defining the attributes include one or more of:
(a) identifying emission reduction credits;
(b) identifying tradable renewable credits;
(c) identifying independent power production credits;
(d) identifying grid congestion credits;
(e) identifying royalty credits;
(f) identifying green tag credits; and
(g) identifying power production credits.

28. The methods of claim 29 wherein the identified credits include one or more of:
(a) identifying federal tax credits;
(b) identifying state tax credits;
(c) identifying utility credits;
(d) identifying third-party credits;
(e) identifying subsidies; and
(f) identifying rebates.

29. The method of claim 28 wherein identified credits exist now or will exist in the future.

30. The method of claim 28 wherein identified royalty credits include one or more of the following:
(a) an option to purchase some or all of the CPE;
(b) a divided or undivided interest in the CPE;
(c) a right to receive a certain amount of the output from the CPE; and
(d) royalty interests in the CPE.

31. A financial instrument supporting a consumer in financing purchase, lease, installation, and/or maintenance of renewable energy consumer premises equipment (CPE) suitable for installation and power generation at a consumer premises, the financial instrument comprising:
a power attribute security interest in at least one power attribute associated with power generated by the CPE;
a security interest in at least one CPE attribute associated with physical assets of the CPE.

32. A financial instrument as recited in claim 31, wherein the at least one power attribute associated with power generated by the CPE is one or more of:
(a) emission reduction credits;
(b) tradable renewable credits;
(c) independent power production credits;
(d) grid congestion credits;
(e) royalty credits;
(f) green tag credits; and
(g) power production credits.

33. A financial instrument supporting a consumer in financing purchase, lease, installation, and/or maintenance of renewable energy consumer premises equipment (CPE) suitable for installation and power generation at a consumer premises, the financial instrument comprising:
a power security interest in the power generated by the CPE;
a power attribute security interest in a power attribute associated with power generated by the CPE, the power attribute associated with power generated by the CPE including at least one green tag credit; and
a CPE security interest in the physical assets of the CPE.

34. A financial instrument as recited in claim 33 wherein the financial instrument further comprising a second power attribute security interest in a second power attribute associated with power generated by the CPE, the second power attribute including at least one royalty credit.

35. A system supporting financing of a plurality of renewable energy consumer premises equipment (CPE) for a plurality of consumers at a plurality of consumer premises, the system comprising:
a plurality of financial instruments, wherein each specific financial instrument supports a specific consumer in financing purchase, lease, installation, and/or maintenance of a specific CPE suitable for installation and power generation at a specific consumer premises, each specific financial instrument having at least one of:
a security interest in at least one characteristic associated with power generated by the specific CPE;
a CPE physical asset security interest in at least one characteristic associated with physical assets of the CPE; and
a market supporting creating and trading the plurality of financial instruments.

36. A system as recited in claim 35 further comprising:
a mechanism for bundling more than one of the plurality of financial instruments for trading on the market.

37. A system as recited in claim 35 wherein the mechanism for bundling combines financial instruments based on varying types of renewable energy CPE including solar power CPE and wind power CPE.

38. A method of financing renewable energy consumer premises equipment (CPE) for power generation at a consumer premises, a power output of the CPE sold in a power purchase agreement or a power contract, the method comprising:
taking an assignment in the power purchase agreement or the power contract.

39. A method of financing renewable energy consumer premises equipment (CPE) by a consumer for power generation at a consumer premises, the CPE and/or the real property on which the CPE is disposed having a long term lease associated therewith, the method comprising:
taking an assignment in the long term lease associated with the CPE and/or the real property.

40. A method of financing renewable energy consumer premises equipment (CPE) by a consumer for power generation at a consumer premises, the power having power attributes associated with power separate and apart from naked power, the method comprising:
taking an assignment in the power attributes.

41. The method of claim of claim 40 wherein the power attributes include one or more of the following:
(a) emission reduction credits;
(b) tradable renewable credits;
(c) independent power production credits;
(d) grid congestion credits;
(e) royalty credits;
(f) green tag credits; and
(g) power production credits.

42. A method of financing renewable energy consumer premises equipment (CPE) by a consumer for power generation at a consumer premises, the CPE having CPE attributes associated with CPE separate and apart from naked CPE, the method comprising:
taking an assignment in the CPE attributes.

43. The method of claim of claim 40 wherein the CPE attributes include one or more of the following:
(a) emission reduction credits;
(b) tradable renewable credits;
(c) independent power production credits;
(d) grid congestion credits;
(e) royalty credits;
(f) green tag credits; and
(g) power production credits.
